(19) United States
(12) Patent Application Publication
(10) Pub. No.: US 2022/0089421 A1
(43) Pub. Date: Mar. 24, 2022

(54) ACCESSORY MOUNT SYSTEM FOR USE WITH ELEVATED WORK PLATFORMS

(71) Applicant: Klein Tools, Inc., Lincolnshire, IL (US)

(72) Inventors: Scott Hargis, North Brook, IL (US); John Kargenian, Prospect Heights, IL (US); Jonathan Gimondo, Arlington Heights, IL (US); Zachary Carlins, Boston, MA (US)

(73) Assignee: Klein Tools, Inc., Lincolnshire, IL (US)

(21) Appl. No.: 17/477,689

(22) Filed: Sep. 17, 2021

Related U.S. Application Data
(60) Provisional application No. 63/080,296, filed on Sep. 18, 2020.
(60) Provisional application No. 63/118,482, filed on Nov. 25, 2020.

(51) Int. Cl. B66F 13/00; F16M 13/02; F16B 2/18

(52) U.S. Cl. CPC B66F 13/00; B66F 11/044; F16B 2/185; F16M 13/02

(57) ABSTRACT

An accessory mount system is provided for mounting on an aerial work platform having sidewalls extending upwardly from a base to a rim or lip. The mount system is configured to be releasably attached to the lip and one or more of the sidewalls of the work platform and includes quick-connect accessory mounts that allow various types of accessories or accessory mount/holders to be mounted on the system and, via the system, on to the work platform. The system can include a quick-connect mechanism for releasably mounting an accessory to the system. The quick-connect mechanism includes a catch mounted to a frame to pivot between a release position and a lock position and a user actuated release lever connected to the catch to allow a user to actuate the catch from the lock position to the release position.

### CROSS-REFERENCE TO RELATED APPLICATIONS

This application claims priority to U.S. Patent Applications 63/080,296 filed Sep. 18, 2020, and 63/118,482 filed Nov. 25, 2020; and the entirety of both applications are incorporated by reference herein.

### BACKGROUND OF THE DISCLOSURE

The present disclosure relates to accessory mount systems utilizing quick-connect accessory mounts, and in more specific applications to such systems specifically designed for use on elevated/aerial work platforms having sidewalls and an upper lip. One type of such work platform having solid sidewalls is commonly referred to as lift buckets or insulated aerial lift platforms and are provided on lift trucks to elevate line workers in the power distribution, telephone line, and cable service industries so that the workers can service and install elevated power lines, telephone lines, and cable lines. Other types of workers, such as arborists, that must work at height to perform their jobs also often utilize such work platforms or aerial work platforms that have open sidewalls in the form of railings that are typically defined by vertical posts with horizontal cross members extending between the vertical posts to form a fence-like sidewall.

Brackets, hooks, and other devices for mounting accessories (such as hand tools, supplies, ropes, wiring, containers, etc.) on the sidewalls and lip if aerial work platforms are known, but there is a continuing desire for improved means for mounting accessories on aerial work platforms, including components and systems that allow for a variety of accessories to be mounted at a variety of locations on aerial work platforms, that can provide improved ergonomics, optimized flexibility and/or other additional features.

### BRIEF SUMMARY OF THE DISCLOSURE

In accordance with some features of this disclosure, the following are examples of some of the inventive concepts that could be claimed according to this disclosure:

1A. An accessory mount system for use with an elevated lift platform having sidewalls extending upwardly from a base to a rim, the mount system comprising:

a first frame member supporting a first horizontally extending mount rail;

a second frame member supporting a second horizontally extending mount rail; and

a third frame member configured to connect the first frame member and the second frame member while extending over a rim of a lift platform with the first frame member and first horizontally extending mount rail overlaying an interior side of a sidewall of the lift platform and the second frame member and the second horizontally extending mount rail overlaying an exterior side of the sidewall of the lift platform.

2A. The mount system of claim 1A wherein the first frame member supports a plurality of horizontally extending mount rails.

3A. The mount system of claim 2A wherein the first, second, and third frame members and the rails are formed as a unitary component.

4A. The mount system of claim 2A wherein at least one of the first, second, and third frame members is formed as a separate component that is assembled to the other of the first, second, and third frame members.

5A. The mount system of claim 1A wherein each of the mount rails has an upper horizontally extending edge.

6A. The mount system of claim 5A wherein each of the mount rails has an outwardly facing concave portion located below the upper horizontally extending edge, the concave portion extending horizontally over a length of the rail.

7A. The mount system of claim 5A wherein each of the mount rails has a lower horizontally extending edge spaced vertically below the upper horizontally extending edge.

8A. The mount system of claim 7A wherein each of the mount rails has an outwardly facing concave portion located between the upper and lower horizontally extending edges, the concave portion extending horizontally over a length of the rail.

9A. The mount system of claim 1A wherein the first frame member comprises a vertical wall panel.

10A. The mount system of claim 9A wherein the vertical wall panel has an array of openings extending through the wall panel.

11A. The mount system of claim 9A wherein the first horizontal rail is attached the vertical wall panel by a plurality of spaced, cantilevered posts extending between the vertical wall panel and the rail.

12A. The mount system of claim 1A further comprising at least one quick-connect accessory mount configured to engage each of the mount rails.

1B. An accessory mount system for use with an elevated lift platform having sidewalls extending upwardly from a base to a rim, the mount system comprising:

a first wall panel comprising a first plurality of recessed slots, each slot having at least one rib and configured to engage at least one quick-connect accessory mount;

a second wall panel; and

an upper frame member configured to connect the first and second wall panels while extending over a rim of a lift platform with the first wall panel overlaying an interior side of a sidewall of the lift platform and the second wall panel overlaying an exterior side of the sidewall of the lift platform;

wherein at least one of the second wall panel and the upper frame member comprises at least one additional recessed slot having at least one rib and configured to engage at least one quick-connect accessory mount.

2B. The accessory mount system of claim 1B wherein the second wall panel comprises the at least one additional recessed slot.

3B. The accessory mount system of claim 1B wherein the upper frame member comprises the at least one additional recessed slot.

4B. The accessory mount system of claim 1B wherein each of the recessed slots is defined by a corresponding horizontally extending mount rail, each of the horizontally extending mount rails comprising an upwardly extending rib extending over a horizontal length of the mount rail

5B. The accessory mount system of claim 1B wherein the at least one additional recessed slot is a second plurality of recessed slots, each slot of the second plurality having at least one rib configured to engage at least one quick-connect accessory mount.

6B. The accessory mount system of claim 1B wherein the at least one rib of each recessed slots comprises a pair of ribs extending from spaced sidewalls of the recessed slot.

7B. The mount system of claim 1B further comprising at least one quick-connect accessory mount configured to engage each slot.

1C. An accessory mount system for use with an elevated lift platform having sidewalls extending upwardly from a base to a rim, the mount system comprising:

a pair of first frame members, each first frame member supporting a corresponding first mount structure configured to engage at least one quick-connect accessory mount;

a pair of second frame members;

a pair of third frame members, each of the third frame members configured to connect one of the first frame members and one of the second frame members while extending over a rim of a lift platform with the one of the first frame members overlaying an interior side of a sidewall of the lift platform and the one of the second frame members overlaying an exterior side of the sidewall of the lift platform; and

a corner frame member configured to join at least one of the pairs of first, second, and third frame members with each of the third frame members connecting one of the first frame members and one of the second frame members;

wherein at least one of the second and third frame members supports at least one additional mount structure configured to engage at least one quick-connect accessory mount.

2C. The mount system of claim 1C wherein the corner frame member is configured to join all of the pairs of first, second, and third frame members with each of the third frame members connecting one of the first frame members and one of the second frame members.

3C. The mount system of claim 1C wherein one of the first frame members and one of the third frame members are formed as a unitary component.

4C. The mount system of claim 1C wherein at least one of the first, second, and third frame members of each pair is formed as a separate component that can be assembled to the other of the first, second, and third frame members of each pair.

5C. The mount system of claim 1C wherein the corner frame member is formed as a separate component that can be assembled to at least one of the pairs of first, second, and third frame members.

6C. The mount system of claim 1C wherein each of the first frame members comprises a vertical wall panel.

7C. The mount system of claim 1C wherein each of the second frame members comprises a vertical wall panel.

8C. The mount system of claim 1C wherein each of the first frame members is a separate component, and each of the first mount structures is a separate component that is assembled to the corresponding first frame member.

9C. The mount system of claim 1C wherein at least one of the mount structures comprises a horizontal mount rail.

10C. The mount system of claim 1C wherein at least one of the mount structures comprises a recessed slot having a pair of ribs extending from spaced sidewalls of the recessed slot.

11C. An accessory mount system for use with an elevated lift platform having sidewalls connected to each other by corner walls, the sidewalls and corner walls extending upwardly from a base to a rim, the mount system comprising:

a corner frame member configured to extend over and engage a corner wall of a lift platform, the corner frame member comprising a first portion that overlays a rim of the lift platform and a second portion that overlays an interior side of the corner wall, the frame member supporting at least one accessory mount.

12C. The accessory mount system of claim 11C further comprising at least one accessory mount structure carried on the corner frame member.

13C. The accessory mount system of claim 12C wherein the at least one accessory mount structure comprises a hook shaped accessory mount mounted to the corner frame member to pivot relative to the corner frame member between a stowed position and a ready position wherein one or more accessories can be hung from the hook shaped accessory mount.

14C. The accessory mount system of claim 13C wherein the hook shaped accessory mount includes a cylindrical portion that mounted in a mount bore to pivot between the stowed and ready positions.

15C. The accessory mount system of claim 14C wherein the cylindrical portion is mounted to translate along an axis relative to the corner frame member.

16C. The accessory mount system of claim 12C wherein the at least one accessory mount structure comprises an arcuate shaped rod mounted to the corner frame member to pivot between a stowed position wherein the rod overlays a concave surface of the corner frame member and a deployed position wherein the rod curves oppositely outwardly from the concave surface to allow one or more accessories to be hung from the rod.

1D. An accessory mount system for use with an elevated lift platform having sidewalls extending upwardly from a base to a rim, the mount system comprising:

a first frame member;

a second frame member;

a third frame member configured to connect the first frame member and the second frame member while extending over the rim of a lift platform with the first frame member overlaying an interior side of a sidewall of the lift platform and the second frame member overlaying an exterior side of the sidewall of the lift platform; and

a catch member connected to at least one of the first, second, and third frame members for movement between a release position and a stop position, in the release position the catch member located to allow the frame members to be removed from the sidewall of the lift platform and in the stop position the catch member located to contact either at least one of the exterior side or the rim to prevent removal of the frame members from the sidewall of the lift platform.

2D. The accessory mount system of claim 1D wherein at least one of the first, second, and third frame members supports at least one accessory or accessory mount.

3D. The accessory mount system of claim 2D wherein the at least one of the first, second, and third frame members includes at least one mount structure configured to engage at least one quick-connect accessory mount.

4D. The mount system of claim 3D wherein the at least one of mount structure comprises a horizontal mount rail.

5D. The mount system of claim 3D wherein the at least one of mount structure comprises a recessed slot having a pair of ribs extending from spaced sidewalls of the recessed slot.

6D. The accessory mount system of claim 1D wherein the first frame member supports a first mount structure configured to engage at least one quick-connect accessory mount.

7D. The mount system of claim 6D wherein the first frame member and the first mount structure are each a separate component that is assembled to the other of the first frame member and the first mount structure.

8D. The accessory mount system of claim 6D wherein the second frame member supports a second mount structure configured to engage at least one quick-connect accessory mount.

9D. The mount system of claim 1D wherein the first frame members and the third frame members are formed as a unitary component.

10D. The mount system of claim 1D wherein the first, second, and third frame members are each formed as a separate component that can be assembled to the other of the first, second, and third frame members.

11D. The mount system of claim 1D wherein the first frame member is a vertical wall panel.

12D. The mount system of claim 1D wherein the second frame member is a vertical wall panel.

13D. The mount system of claim 1D wherein the catch member is mounted to pivot between the release and stop positions.

14D. The mount system of claim 1D wherein the catch member further includes a user actuated lever configured to allow a user to actuate the catch member from the stop position to the release position.

15D. The mount system of claim 1D wherein the system further comprises an end component connected to the first, second and third frame members and mounting the catch member for movement between the release and stop positions.

1E. A quick-connect mechanism for releasably mounting an accessory to an accessory mount system, the quick-connect mechanism comprising:

a frame comprising a first surface, a second surface spaced from the first surface and facing the first surface, and a channel defined between the first and second surfaces to receive a mount structure to which the mechanism can be mounted;

a catch mounted to the frame to pivot between a release position and a lock position, in the lock position the catch extends from the frame to a position that blocks removal of a mount structure received in the channel, in the release position the catch is positioned relative to the channel to allow a mount structure to inserted into and removed from the channel, the catch being biased toward the lock position; and

a user actuated release lever connected to the catch to allow a user to actuate the catch from the lock position to the release position, the release lever and the catch connected to allow relative movement between the release lever and the catch as the catch is actuated from the lock position to the release position by a mount structure being inserted into the channel.

2E. The quick-connect mechanism of claim 1E wherein the release lever is mounted to pivot relative to the frame between a ready position and a unlock position, the catch moving from the lock position to the release position in response to the release lever moving from the ready position to the unlock position.

3E. The quick-connect mechanism of claim 2E wherein the release lever and the catch are mounted to pivot about a common axis.

4E. The quick-connect mechanism of claim 1E wherein the catch extends from the first surface in the lock position.

5E. The quick-connect mechanism of claim 1E wherein the frame defines a gap through which a mount structure must pass to be inserted into the channel, and the catch extends into the gap in the lock position.

6E. The quick-connect mechanism of claim 5E wherein the catch is removed from the gap in the release position.

7E. The quick-connect mechanism of claim 1E further comprising a spring engaged between the frame and the catch to bias the catch to the lock position.

8E. The quick-connect mechanism of claim 1E wherein at least a portion of the first surface and at least a portion of the second surfaces are planar.

9E. The quick-connect mechanism of claim 1E wherein the frame further comprises a third surface extending from the first surface to the second surface.

10E. The quick-connect mechanism of claim 1E wherein the frame further comprises structure for connecting an accessory to the quick-connect mechanism.

11E. A quick-connect mechanism for releasably mounting an accessory to an accessory mount system, the quick-connect mechanism comprising:

a frame comprising a first surface, a second surface spaced from the first surface and facing the first surface, and a channel defined between the first and second surfaces to receive a mount structure to which the mechanism can be mounted, at least a portion of the first surface and at least a portion of the second surfaces are planar;

a catch mounted to the frame to pivot between a release position and a lock position, in the lock position the catch extends from the frame to a position that blocks removal of a mount structure received in the channel, in the release position the catch is positioned relative to the channel to allow a mount structure to inserted into and removed from the channel; and

a user actuated release lever connected to the catch to allow a user to actuate the catch from the lock position to the release position.

12E. The quick-connect mechanism of claim 11E wherein:

the release lever and the catch are connected to allow relative movement between the release lever and the catch as the catch is actuated from the lock position to the release position by a mount structure being inserted into the channel; and

the release lever is mounted to pivot relative to the frame between a ready position and a unlock position, the catch moving from the lock position to the release position in response to the release lever moving from the ready position to the unlock position.

13E. The quick-connect mechanism of claim 12E wherein the release lever and the catch are mounted to pivot about a common axis.

14E. The quick-connect mechanism of claim 11E wherein the catch extends from the first surface in the lock position.

15E. The quick-connect mechanism of claim 11E wherein the frame defines a gap through which a mount structure must pass to be inserted into the channel, and the catch extends into the gap in the lock position.

16E. The quick-connect mechanism of claim 15E wherein the catch is removed from the gap in the release position.

17E. The quick-connect mechanism of claim 11E further comprising a spring engaged between the frame and the catch to bias the catch to the lock position.

18E. The quick-connect mechanism of claim 11E wherein the frame further comprises a third surface extending from the first surface to the second surface.

19E. The quick-connect mechanism of claim 11E wherein the frame further comprises structure for connecting an accessory to the quick-connect mechanism.

20E. The quick-connect mechanism of claim 1E wherein:

the catch includes a plurality of slots, each slot extending from a first stop surface to a second stop surface; and

the lever includes a plurality of fingers, each finger slidably received in a corresponding one of the slots, each finger having a stop surface that engages against the first stop surface of the corresponding one of the slots with the catch in the lock position and the lever in the ready position.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is a perspective view from above and the front of an insulated aerial work platform with an accessory mount system mounted thereon according to this disclosure;

FIG. 2 is a perspective view from the opposite side of the work platform and mount system of claim 1, but showing the mount system mounted without an optional corner component of the system;

FIG. 3 is an enlarged, broken section view taken from line 3-3 in FIG. 2;

FIG. 4 is an enlarged perspective view showing several components of the mount system of FIGS. 1-3;

FIG. 5 is a perspective view showing a different embodiment of the components shown in FIG. 4;

FIG. 6 is an enlarged, broken section view taken from line 6-6 in Fig.;

FIG. 7 is a perspective view similar to FIG. 5, but sectioned from line 7-7 in FIG. 5;

FIG. 8 is an enlarged, broken section view similar to FIG. 3, but showing the embodiment of the components shown in FIGS. 5-7;

FIG. 9 is a broken section view taken from line 9-9 in FIG. 8;

FIG. 10 is a view similar to FIG. 1, but showing another embodiment of the accessory mount system according to this disclosure;

FIG. 11 is a view similar to FIGS. 1 and 10, but showing yet another embodiment of the accessory mount system according to this disclosure;

FIG. 12 is a perspective view of the accessory mount system from FIG. 1, with the work platform removed for purposes of illustration;

FIG. 13A is a perspective view of a corner component of the system according to this disclosure showing an accessory mount rod in a deployed position;

FIG. 13B is a view similar to FIG. 13A but showing the accessory mount rod in a stowed position;

FIGS. 14 and 15 are top plan views of the corner component of FIGS. 13 and 14, with FIG. 14 showing the accessory mount rod in the stowed position and FIG. 15 showing the accessory mount rod in the deployed position;

FIG. 16A is a view similar to FIG. 13A, but showing alternate embodiments of the corner component and the accessory mount rod together with other components of the system;

FIG. 16B is a view similar to FIG. 16A but showing the alternate embodiment of the accessory mount rod in a stowed position;

[symbol]

FIG. 17 is a perspective view of one embodiment of the system according to this disclosure, with the right hand end of the view, including an end component of the system, shown in section for purposes of illustration;

FIG. 18 is an view of the right hand end of FIG. 17;

FIG. 19 is a perspective view similar to FIG. 1 but showing another embodiment of the accessory mount system according to this disclosure mounted on a smaller sized aerial work platform;

FIG. 20 is an enlarged section view taken from line 20-20 in FIG. 19;

FIG. 21 is a perspective view of several frame components of the system shown in FIGS. 19 and 20;

FIG. 22 is a back elevation of the frame components shown in FIG. 21;

FIG. 23 is an enlarged, broken section view taken from line 23-23 in FIG. 19 to better illustrate an quick-connect accessory mount for use with the system according to this disclosure, but with the work platform not shown for purposes of illustration;

FIG. 24 is a broken section view taken from line 24-24 in FIG. 23;

FIG. 25 is a broken section view taken from line 25-25 in FIG. 23;

FIG. 26 is a perspective view similar to FIG. 1 but showing yet another embodiment of the accessory mount system according to this disclosure mounted on an aerial work platform;

FIG. 27 is a perspective view from the opposite side of FIG. 26;

FIG. 28 is a broken, enlarged section view taken from line 28-28 in FIG. 27;

FIG. 29 is a perspective view of an embodiment of a quick-connect accessory mount according to this disclosure, with a user actuated lever in a ready position and a catch component in a lock position;

FIG. 30 is a section view taken from line 30-30 in FIG. 29;

FIG. 31 is a perspective view similar to FIG. 29, but sectioned at line 30-30 in FIG. 29;

FIG. 32 is a left side elevation of the quick-connect accessory mount of FIGS. 29-31;

FIG. 33 is an enlarged view similar to FIG. 30, but showing a catch component in a release position and the accessory mount partially mounted on a mount rail of the system according to this disclosure

FIG. 34 is a view similar to FIG. 33 but showing the accessory mount fully mounted on to the mount rail and with a user actuated lever in an unlock position and the catch component in the release position;

FIG. 35 is an exploded perspective view of the catch component and an axel pin of the quick-connect accessory mount of FIGS. 29-34;

FIG. 36 is a perspective view of the user actuated lever of the quick-connect accessory mount of FIGS. 29-34; and

FIGS. 37-47 are perspective views of several additional embodiments of the accessory mount system according to this disclosure.

### DETAILED DESCRIPTION OF PREFERRED EMBODIMENTS

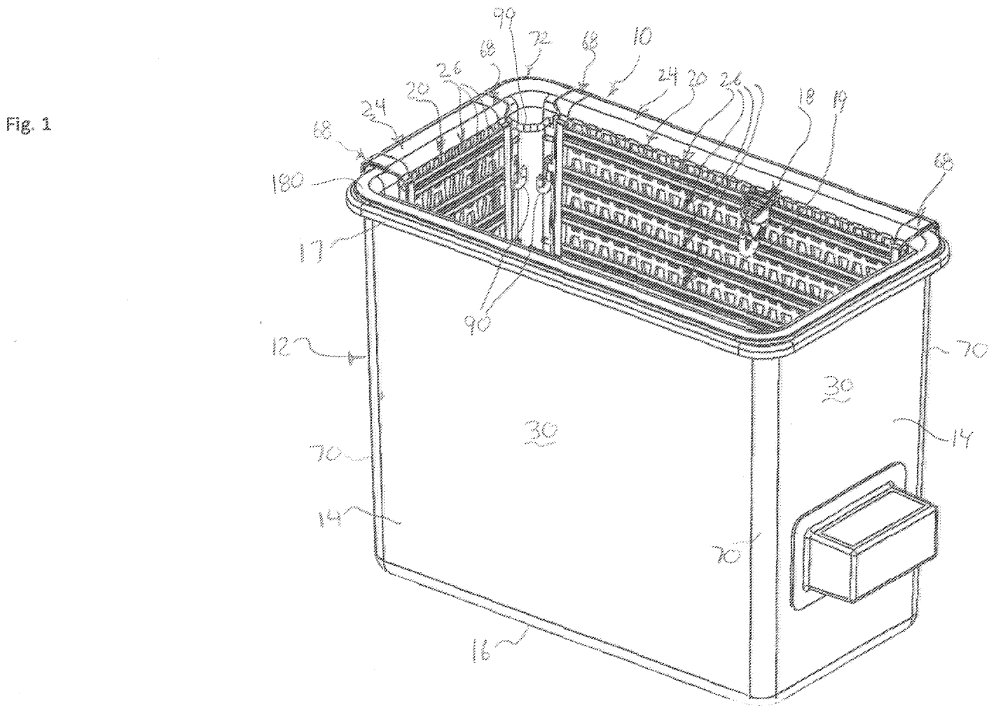

As best seen in FIGS. 1-3, an accessory mount system 10 is provided for mounting on an aerial work platform 12 having sidewalls 14 extending upwardly from a base 16 to a rim or lip 17. The work platform 12 will typically be in the form of a lift bucket 12 having solid, electrically insulated sidewalls 14 as shown in FIGS. 1-5, but can be in any form that has sidewalls 14 and a lip 17, including work platforms 12 wherein the sidewalls 14 and the lip 17 are defined by a railing having vertical posts and horizontal cross members. In the preferred embodiments, the mount system 10 is configured to be releasably attached to the lip 17 and one or more of the sidewalls 14 of the work platform 12 and includes quick-connect accessory mounts 18 that allow various types of accessories or accessory mount/holders 19 to be mounted on the system 10 and, via the system 10, on to the work platform 12.

In the embodiment shown in FIGS. 1-3, the mount system 10 includes a first frame member 20, a second frame member 22, and a third frame member 24. The first frame member 20 includes a plurality of mount structures 26 and the second frame member includes one of the mount structures 26, with each mount structure 26 configured to engage one or more of the quick-connect accessory mounts 18. The third frame member 24 is configured to connect the first frame member 20 and the second frame member while extending over the lip 17 of the platform 12 with the first frame member 20 overlaying an interior side 28 of one of the sidewalls 14 and the second frame member 22 overlaying an exterior side 30 of the sidewall 14.

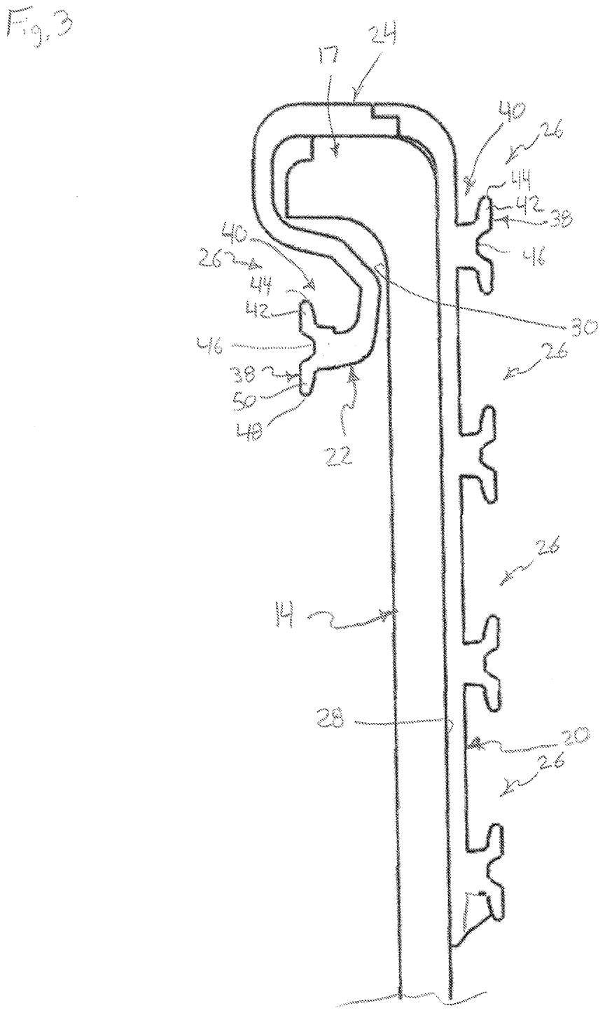

In the illustrated and preferred embodiment shown in FIGS. 1-4, the first frame member 20 and the second frame member 22 are each provided in the form of a wall panel 20 and 22, respectively. Additionally, as best seen in FIG. 3, in the illustrated embodiment, the second and third frame members 22 and 24 are an integrated component. As best seen in FIG. 4, the wall panel 20 of the illustrated embodiment has an array of openings 32 extending completely through the panel 20, and the wall panel 22 has an array of openings 34 extending completely through the panel 22.

In the illustrated and preferred embodiments shown in FIGS. 1-4, the mount structures 26 are each provided in the form of horizontally extending mount rails 38. Each mount rail 38 defines an upwardly opening, recessed slot 40 having at least one upwardly extending rib 42 configured to engage one or more of the quick-connect accessory mounts 20. Each rib 42 includes an upper, horizontally extending edge 44 and, in the illustrated and preferred embodiment, each rail 38 further includes an outwardly facing concave portion 46 extending horizontally over a length of the rail 38 and located vertically below the upper, horizontally extending edge 44. In the illustrated embodiment, each of the mount rails 38 further includes a lower horizontally extending edge 48 spaced vertically below the edge 44 and the concave portion 46, with the edge 48 being defined by a downwardly extending rib 50. As best seen in FIG. 4, each of the mount rails 38 is attached to the corresponding wall panel 20 and 22 by a plurality of spaced, cantilevered posts 52 extending between the corresponding wall panel 20 and 22 and the mount rail 38. Each of the posts 52 is located between two or more of the openings 32 or 34.

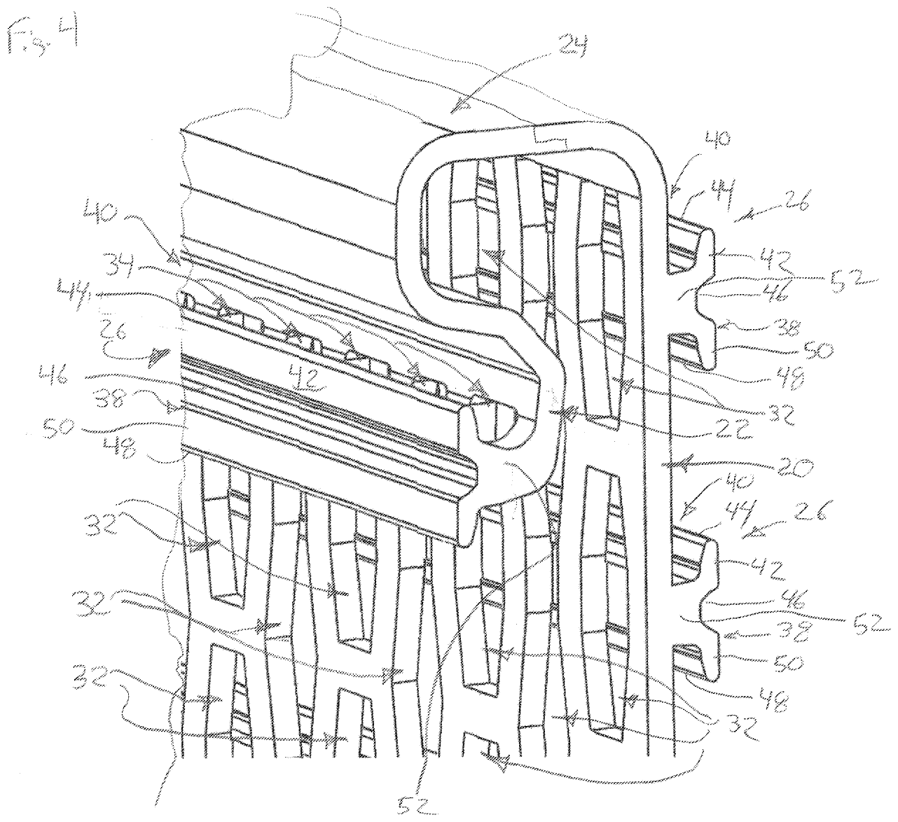

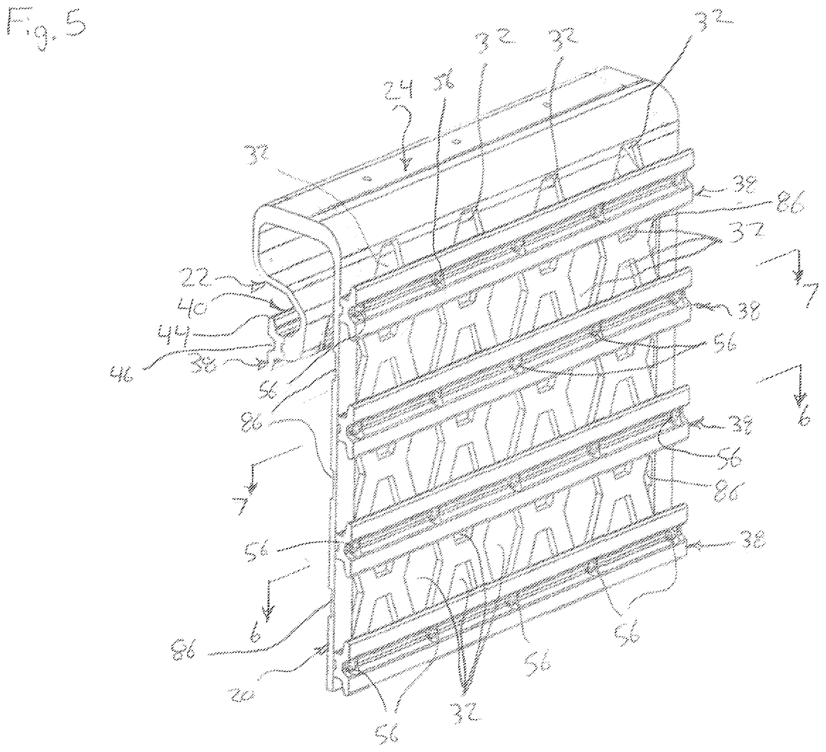

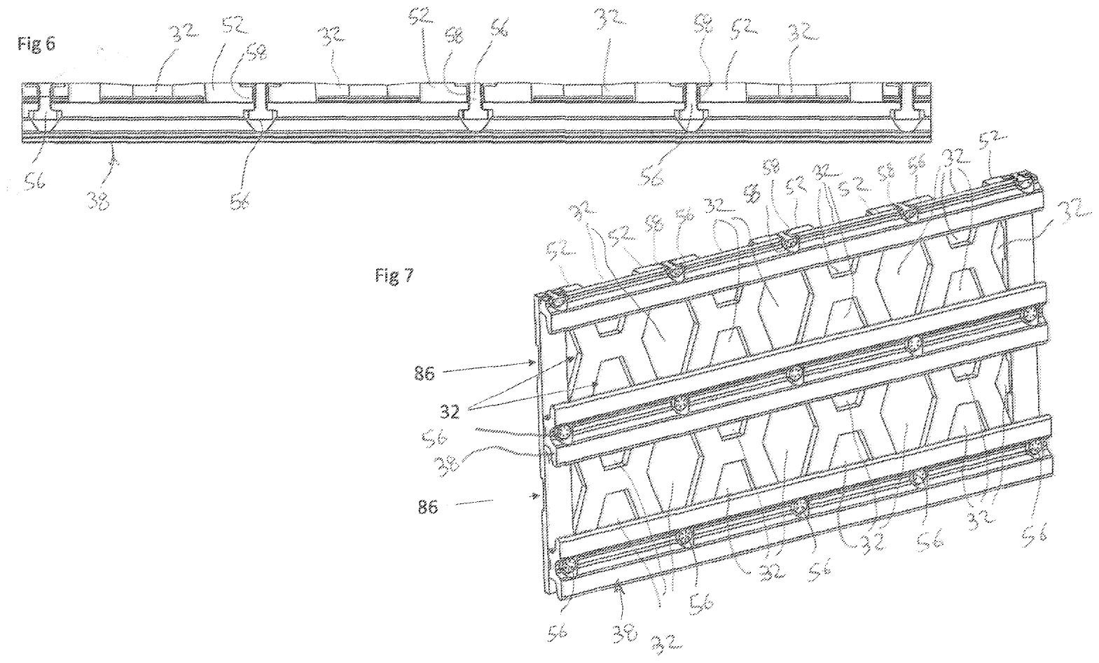

As best seen in FIGS. 3 and 4, in one preferred embodiment, the third frame member 24 and the second wall panel 22 are a unitary structure formed from a single piece of material Alternatively, in some embodiments it may be desirable for the frame member 24 and the second wall panel 22 to be formed as separate components. As another alternative, in some embodiments it may be desirable for the first wall panel 20 and the third frame member to be a unitary structure formed from a single piece of material, or for all of the frame members 20, 22 and 24 to be a unitary structure formed from a single piece of material. As best seen in FIGS. 5-7, in a preferred embodiment, the mount rails 38 are separate components with each of the mount rails 38 being fixed to the corresponding wall panel 20 or 22 by suitable fasteners 56, such as threaded fasteners, rivets, or snap-fit posts, that are received in openings 58 formed in the posts 52. Each of the wall panels 20 and 22 of FIGS. 5-7 is a unitary structure formed from a single piece of material. Alternatively as best seen in FIGS. 3 and 4, in another preferred embodiment, the rails 38 and the corresponding wall panel 20 are a unitary structure formed from a single piece of material, and the rail 38 and the corresponding wall panel 22 are also a unitary structure formed by a single piece of material. The components described herein as a unitary structure formed from a single piece of material will preferably be molded from a suitable polymer or composite, but it should be understood that any suitable material and method of manufacturing can be used. When formed as a separate component, the rails 38 will preferably be molded from a suitable polymer or composite, but again it should be understood that any suitable material, such as a suitable metal, and any suitable method of manufacturing, such as extrusion or machining, can be used.

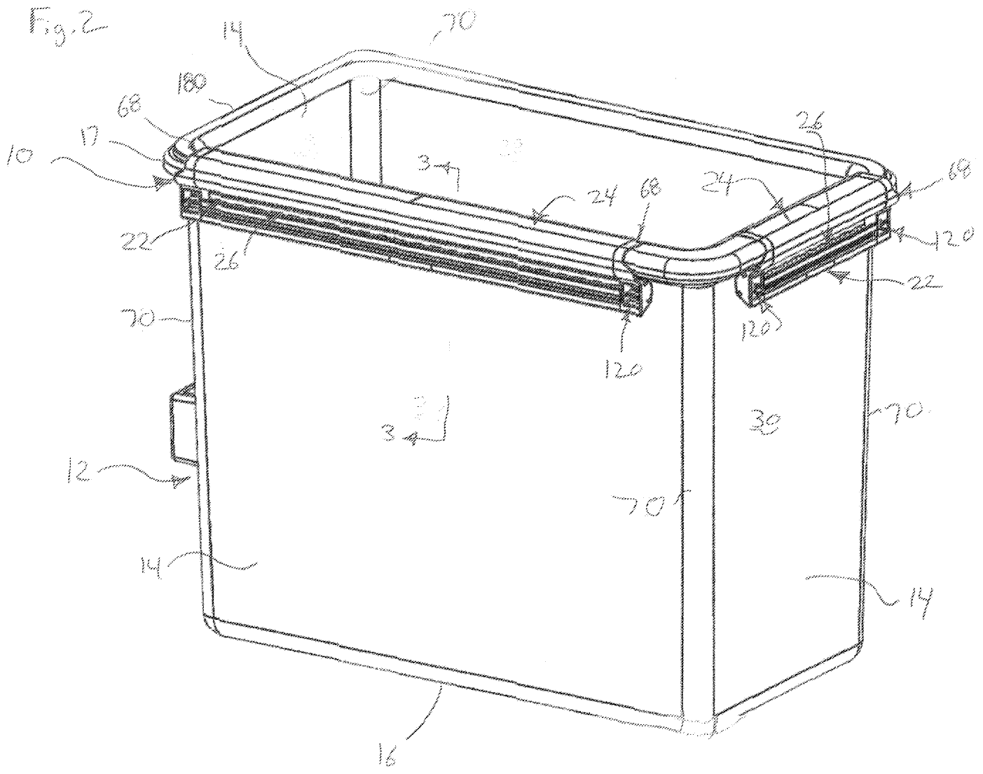

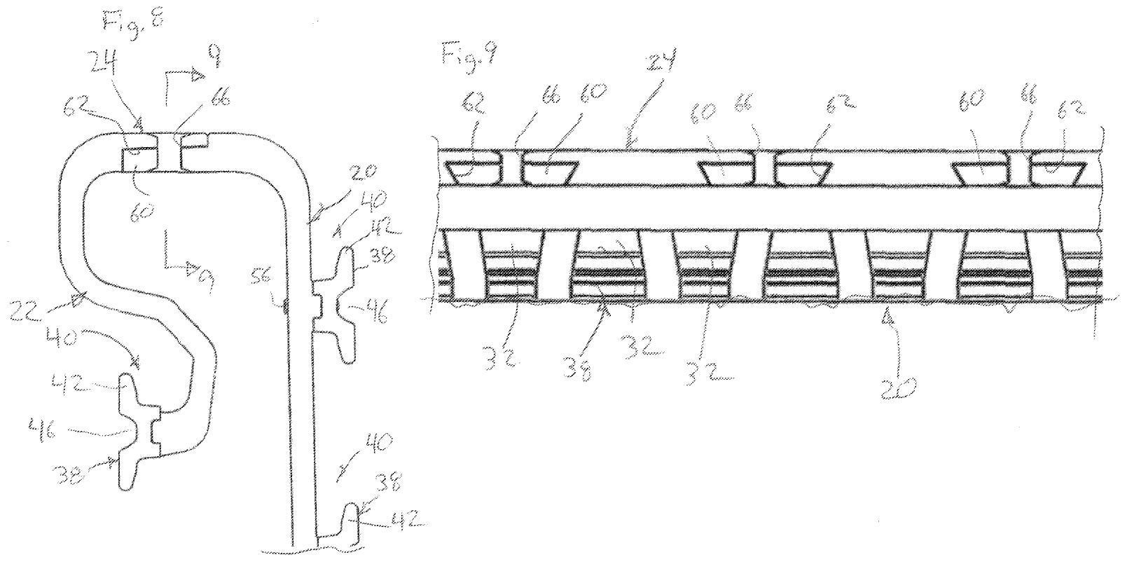

As best seen in FIGS. 8 and 9, in the illustrated embodiment, the first wall panel 20 is attached to the third frame member 24 by a plurality of spaced tongues 60 that extend from the first frame member 20 and are received in conforming slots 62 formed in the third frame member 24, with fasteners 64 extending through openings 66 and 67 in the first and third frame members 20 and 24, respectively, to secure the frame members 20 and 24 together. As best seen in FIGS. 1 and 2, in some embodiments, each of the panels 20 and 22 and the third frame member 24 can extend over substantially the entire horizontal length of a sidewall 14. Alternatively, as best seen in FIGS. 10 and 11, one or more of the panels 20 and 22 and the third frame member 24 can extend over one-half or less of the horizontal length of a sidewall 14, with multiple ones of the panels 20 and 22 and/or third frame members 24 being joined together to span all or some of the horizontal length of the sidewall 14. In this regard, each of the rails 38 can be sized to extend across two or more adjacent panels 20 or 22 so as to connect the adjacent panels 20 and 22. Further in this regard, end components 68 can be provided on the ends of the panels 20 and 22 and third frame members 24 to serve as stops to limit the translation of quick-connect mounts 18 along the rails. The end components 68 can also serve 68 connect adjacent panels 20 and 22 and frame members 24.

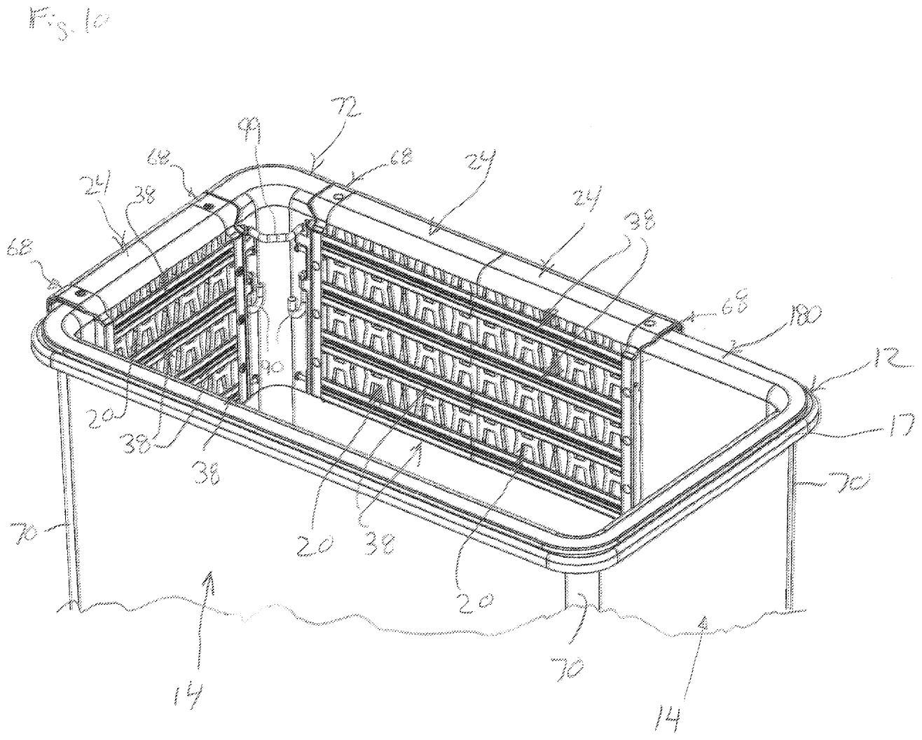

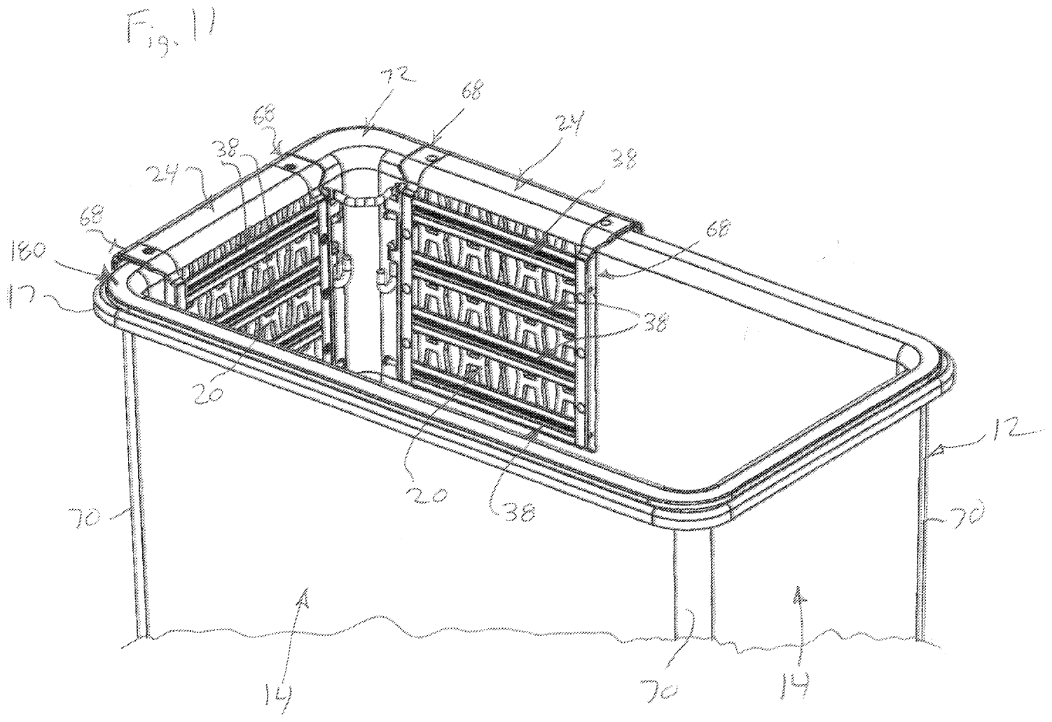

As best seen in FIGS. 1, 10, 11, and 12, the sidewalls 14 of the work platform 12 can be joined to each other by corner walls 70, and the system 10 can also include a corner frame member 72 that is configured to extend over any one of the four corner walls 70. However, it should be understood that in some applications of the system 10, the corner frame members 72 may not be desirable, such as illustrated by the embodiment of FIG. 2. In the illustrated embodiment, the corner frame member 72 has portions 74 and 76 that overlay the rim 17 and the interior side of the corner wall 70, respectively. The corner frame member 72 of the embodiment illustrated in FIGS. 1, 10, 11, 12, 16A, and 16B is a separate component that is assembled to pairs of the frame members 20, 22 and 24 located on adjacent sidewalls 14 to join the pairs at the corner walls 70. In this regard, the corner frame member 72 can be connected directly to a pair of end components 68, with each of the end components 68 being connected directly to a set of the first, second and third frame members 20, 22, and 24 extending over one of the adjacent sidewalls 14. Alternatively, in some embodiments, it may desirable to configure the corner frame member 72 so that it can be connected directly to each set of the frame members 20, 22, and 24 extending over the adjacent sidewalls 14. While any suitable connections can be used, in the illustrated embodiments, spaced tongues 78 extending from interface sides 80 of the corner frame member 72, as best seen in FIGS. 13 and 14, and snap-fit interlock with corresponding grooves 82 extending from interface sides 83 in the end components 68, best seen in FIG. 12, with the interface sides 80 and 83 abutting each other. In some embodiments, the wall panels 20 also include spaced tongues (not shown) similar or identical to the tongues 78 but extending from opposite sides 84 of the wall panels 20 to form a snap-fit interlock with the grooves 82 in the end components 68, with the tongues. As best seen in FIG. 7, in some embodiments where the end components 68 are not used and the corner frame member 72 is attached directly to one or more of the frame members 20, 22, and 24, the wall panels 20 include grooves 86 that receive the tongues 78 with a snap-fit engagement. Additionally, suitable fasteners (not shown) can be used to secure all of the components 20, 22, 24 68, and 72 together.

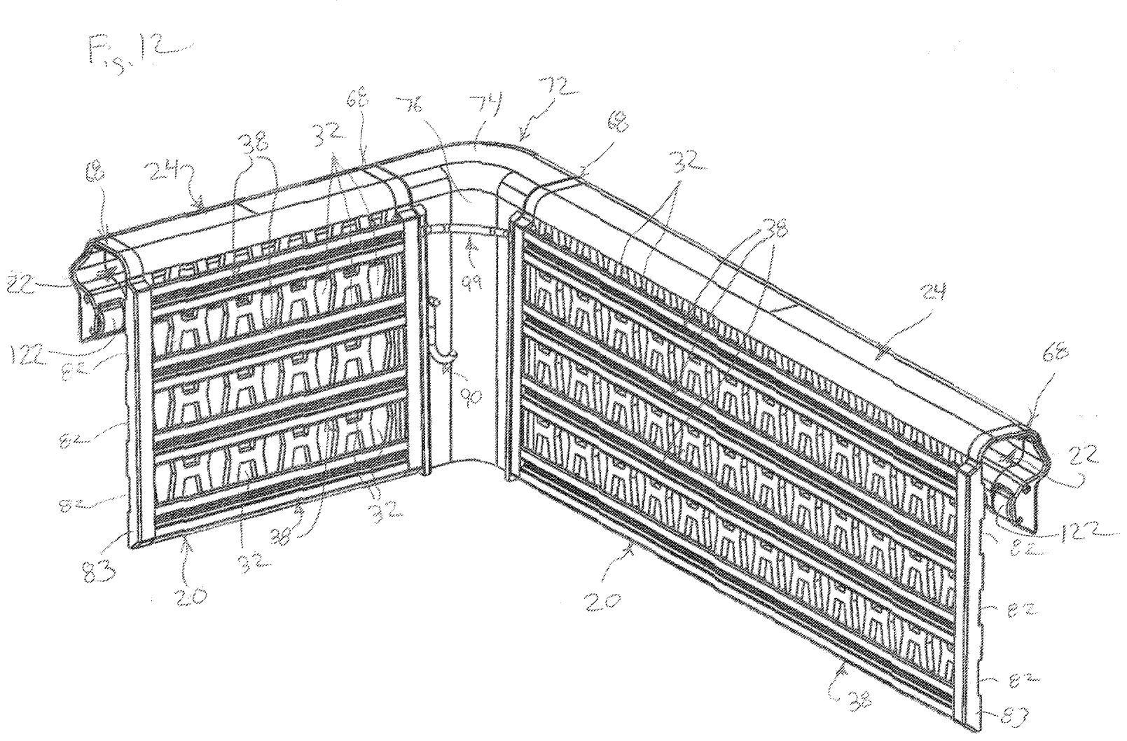

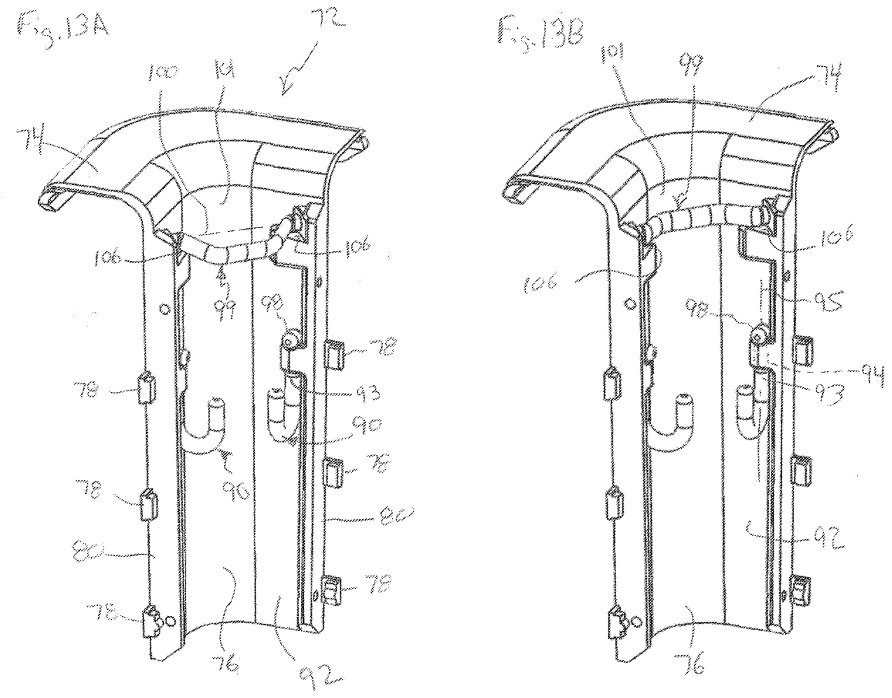

As best seen in FIGS. 13A-16B, the illustrated embodiment, the corner frame member 72 includes a pair of hook shaped accessory mounts 90, each of which is mounted to the corner frame member 72 to pivot between a stowed position shown in FIG. 15 where the mount 90 lays essentially parallel to a surface 92 of the member 72 and a ready position shown in FIGS. 13 and 14 where the mount 90 extends essentially perpendicular to the surface 92 to allow one or more accessories to be hung from the mount 90. In this regard, as best seen in FIG. 13B, each of the mounts 90 includes a cylindrical portion 93 that is mounted in a mount structure provided in the form of a vertically extending, mount bore 94 formed in the member 72 to pivot about and translate along a vertical axis 95 relative to the member 72. The member 72 includes grooves that receive a cylindrical end portion 98 of the mount 90 in the stowed and ready positions, respectively, to retain the mount 90 in each of the positions. Preferably, the grooves conform to the cylindrical shape of the end portion 98. The corner frame member 72 also includes another accessory mount in the form of an arcuate shaped mount rod 99 that is mounted to the member 72 to pivot about a horizontal axis 100 between a stowed position wherein the rod 99 overlays a concave surface 101 of the member 72, as shown in FIGS. 14 and 15, and a deployed position where the rod 99 is positioned so that is curves oppositely outwardly from the surface 101 to allow one or more accessories to be hung from the rod 99, as best seen in FIGS. 13 and 16. In this regard, opposite cylindrical ends 102 of the rod 99 are pivot mounted in a mount structure provided in the form of respective mount bores 104 formed in the member 72, and the member 72 includes stop surface 106 and 108 that abut the rod 99 to retain the rod 99 in the stowed and deployed positions, respectively. FIGS. 16A and 16B illustrate an alternate embodiment for the mount rod 99 and some corresponding features on the corner frame member 72 wherein the mount rod 99 includes a pair of stop feet 112 that engage the surfaces 92 of the frame member 72 to retain the mount rod 99 in the stowed position. Because they are not needed and would interfere with the stop feet 112, the stop 106 and associated underlying structure have been removed from the frame member 72 in the embodiment of FIGS. 16A and 16B.

While the corner frame member 72 has been described and shown herein as being used in connection with the frame members 20, 22, and 24, it should be understood that in some applications of the system 10, it may be desirable to utilize on or more of the corner frame members 72 alone, without any of the frame members 20, 22, and 24, to serve as an accessory mount for an elevated work platform 12. Additionally, it should be understood that in some applications it may be desirable to the corner frame member 25 to incorporate types of accessory mounts and mount structures other than the accessory mounts 90 and 99 shown in the illustrated embodiments, including any of the other mount structures 26 described herein. Furthermore, it should be understood that either alone or together, the accessory mounts 90 and 99 are not limited to use on the corner frame member 72 and can be mounted on other types of support structures, including for example any of the other frame members 20, 22, and 24 disclosed here.

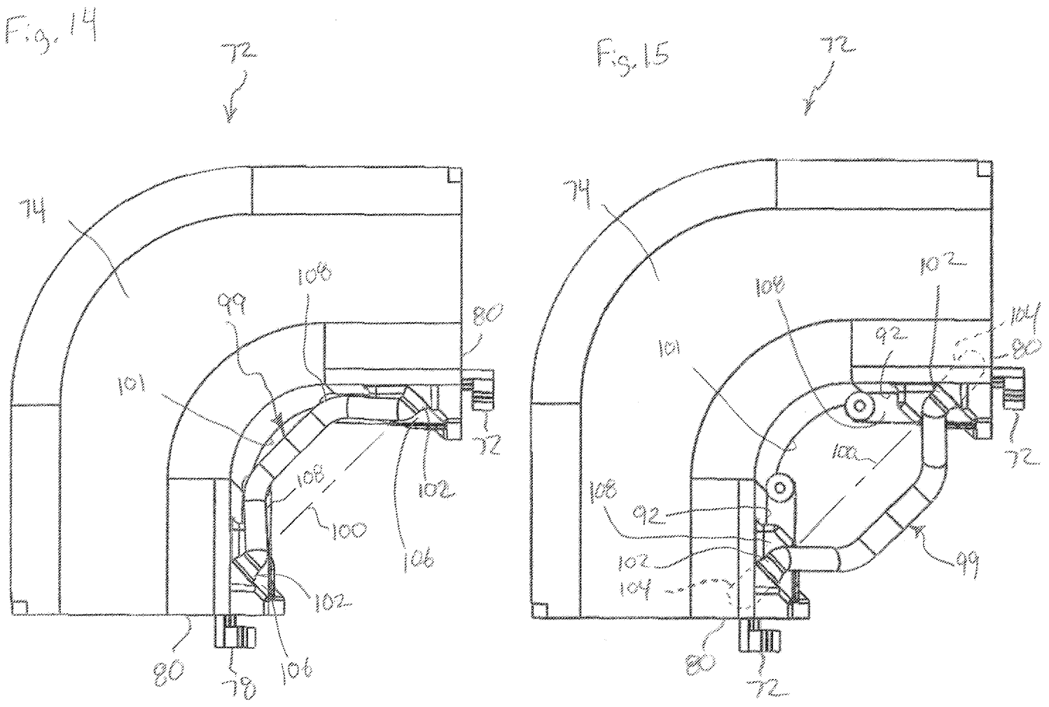

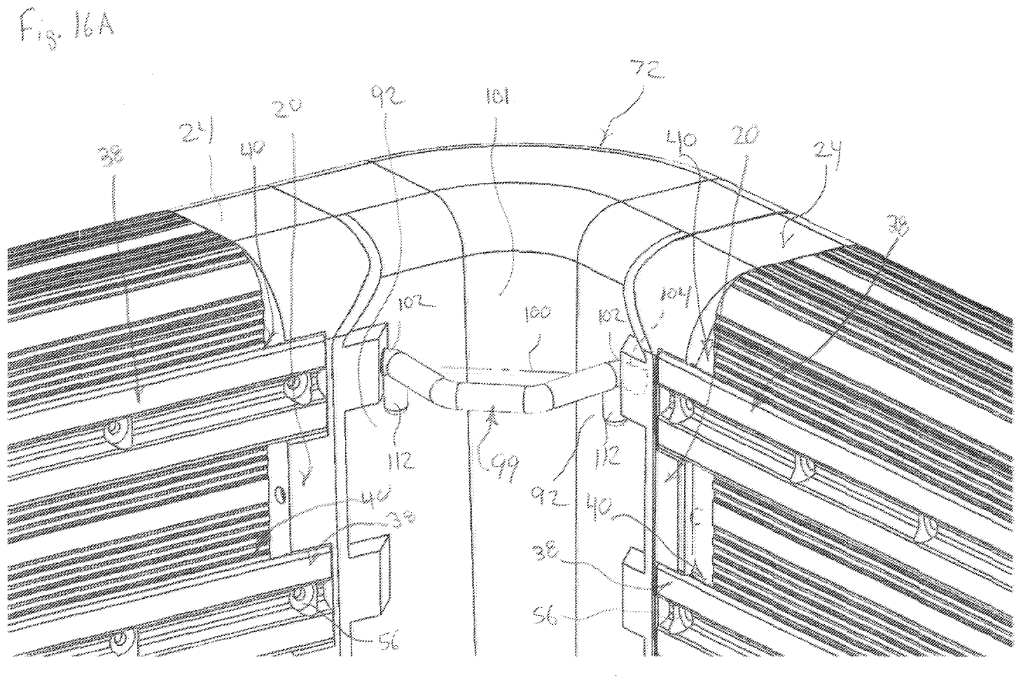

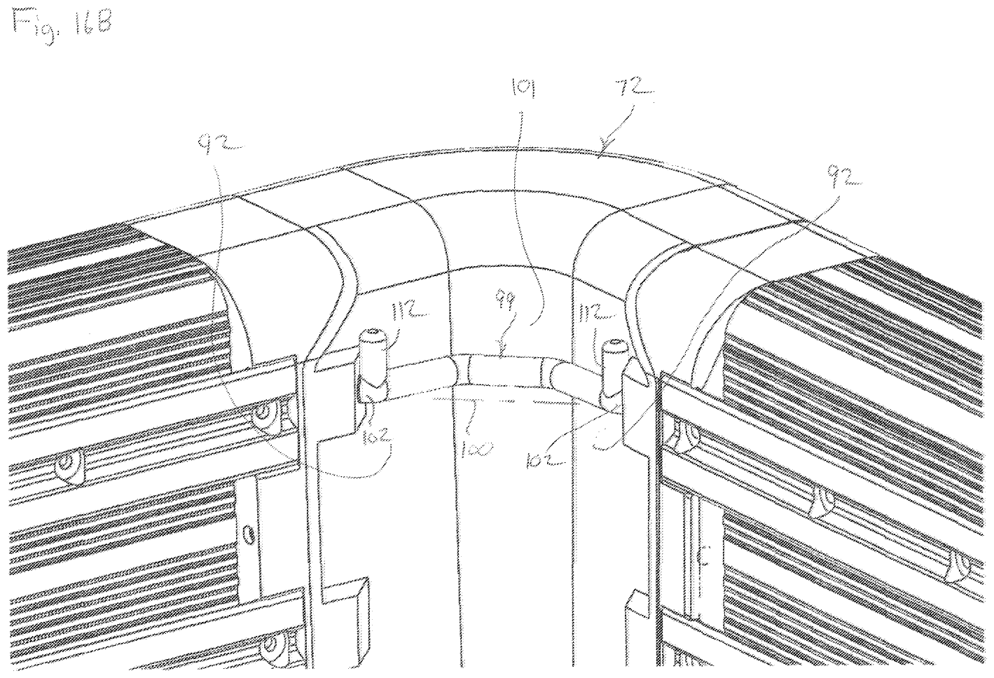

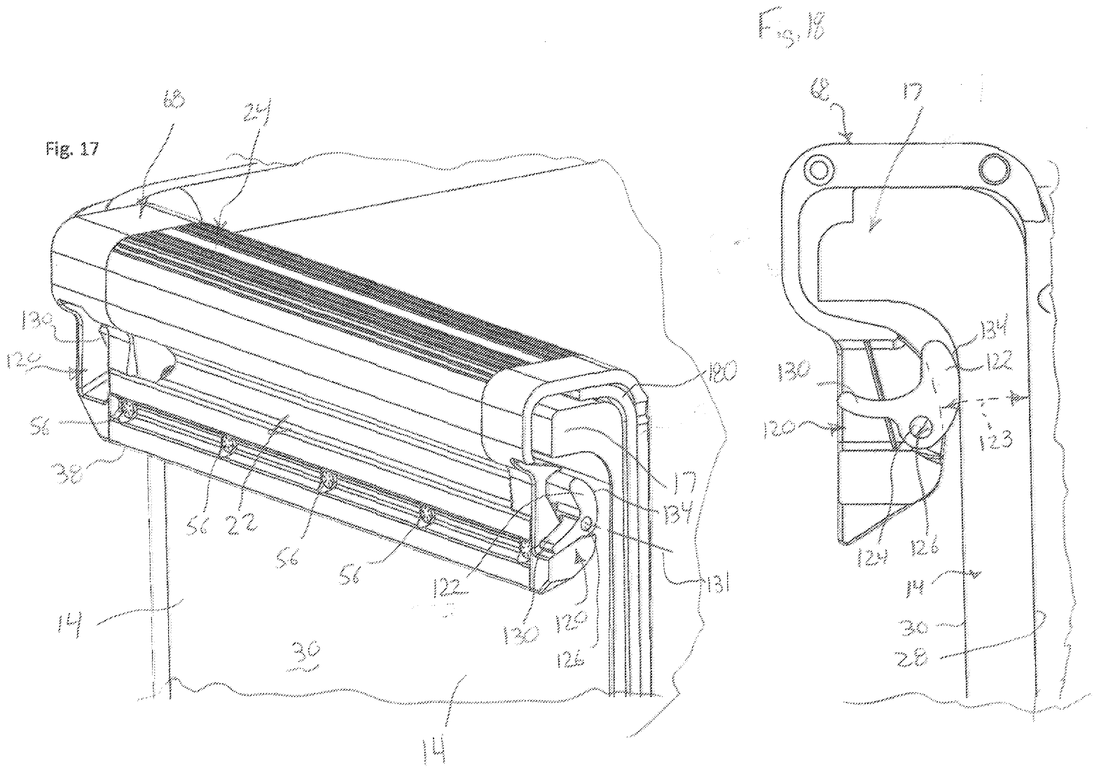

As best seen in FIGS. 17 and 18, in the illustrated and preferred embodiments, the system 10 also includes quick-connect mechanisms 120 for releasably mounting the frames 20, 22, and 24 and the end components 68 to the sidewall 14 and lip 17. The mechanism 120 includes a catch 122 that is mounted to end component 68 to pivot between a lock position shown in FIGS. 2 and 18, and a release position shown in FIGS. 12 and 17. In the lock position, the catch 122 is positioned relative to the frame members 20, 22, and 24 and the end component 68 to engage the lip 17 if the frame members 20, 22, and 24 and end component 68 are moved in an upward direction, which prevents the frame members 20, 22, and 24 and end component 68 from being removed from their mounted position on the sidewall 14 and the lip 17. In the release position, the catch 122 is positioned relative to the frame members 20, 22, and 24 and the end component 68 so that the catch 122 doesn't engage the lip 17 if the frame members 20, 22, and 24 and the end component 68 are moved in an upward direction, thereby allowing the frame members 20, 22, and 24 and the end component 68 to be removed from their mounted position on the sidewall 14 and the lip 17. In this regard, the end component defines a gap, shown at 123, through which the lip 17 must pass as the system 10 is mounted and unmounted from the lip 17 and the sidewall 14. In the lock position, the catch 122 extends into the gap 123 and, in the release position, the catch 122 is removed from the gap 123. The catch mechanism 120 further includes a cylindrical shaped, pivot pin 124 that extends through a cylindrical shaped journal bore 126 formed in the catch 122 to pivot mount the catch 122 to the end component 68. In this regard, opposite ends of the pivot pin 124 are received in mount bores 126 formed in the end component 68. The mechanism 120 further includes user actuated lever 130 that is connected to the catch 122 to allow a user to actuate the catch 122 from the lock position to the release position. In the illustrated embodiment, the catch 122 and the lever 130 are part of a unitary component that is formed from a single piece of material so that the catch 122 and the lever 130 always pivot together about a horizontal axis 131 defined by the pivot pin 124. Preferably, the catch 122 is biased toward the lock position either by the force of gravity G acting on the center of mass 132 of the catch 122 or by a suitable spring engaged between the catch 122 and the end component 68, or by both a suitable spring and by gravity acting on the center of mass 132 of the catch 122. In the preferred embodiment, a helical torsion spring (not shown) is piloted on the pin 124 with one leg engaged against a stop on the end component 68 and the other leg engaged against the catch 122, but other types of springs and engagement configurations may be used, including, for example, helical compression and tension springs, leaf springs, and clock springs. Additionally, in the illustrated and preferred embodiment, the catch 122 has an arcuate shaped cam surface 134 that is shaped to urge the catch 122 toward the release position when the surface engages the lip 17 and/or the side wall 14 as the mechanism 120 and the end component are mounted onto the lip 17 and side wall 14, and to urge the catch 122 further into the lock position when the surface 134 engages either the lip 17 or the side wall 14 if the mechanism 120 and the end component are moved upwardly while the catch is in the lock position. While in the illustrated embodiment and preferred embodiment, a quick-connect mechanisms 120 is mounted in each of the end components 68, it should be understood that in some embodiments it may be desirable for one or more quick-connect mechanism 120 to be mounted in each of the second frame members 22 utilizing the same or similar mount structure as that shown for the end components 68. Furthermore, it should be understood that in some embodiments it may be desirable for the system 10 to not include any of the quick-connect mechanisms 120 or to include a different type of quick-connect mechanism than what is shown herein.

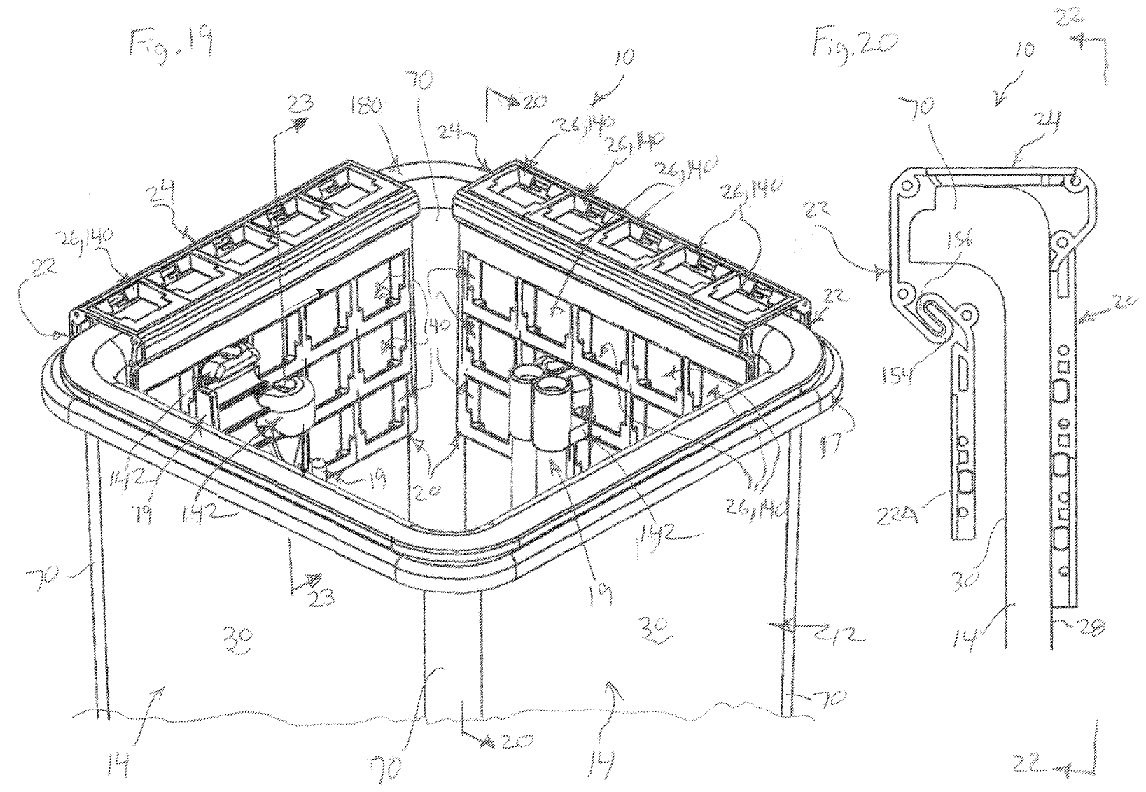

FIGS. 19-25 illustrate another embodiment of the system 10 wherein the mount structures 26 are provided in the panels 20 and 22 and the frame member 24 in the form of recessed slots 140 configured to engage quick-connect accessory mounts 142. As best seen in FIGS. 21 and 22, each recessed slot 140 has a pair of ribs 144 extending towards each other from opposite sidewalls 146 of the slot 140. The ribs 144 are configured to engage mating ribs 148 on the quick-connect accessory mount 142 to retain the quick-connect accessory mount in the slot 140. Each slot 140 further includes a catch feature 150 configured to engage a spring-biased, movable catch or latch 152 on the quick-connect accessory mount 142. The slots 140 are open on the side of the panels 20 and 22 and the panel 24 that face the sidewall 14 and the lip 17, respectively. The slots 140 in the panels 20 and 22 also have bottom openings 153 to avoid the buildup of snow, moisture, rain or other debris in the slots 140 when the system 10 is mounted on a platform 12. In the embodiment of the system 10 shown in FIGS. 19-25, the panels 20 and 22 and the third frame member 24 are a single, unitary component formed from a single piece of material that is molded from a suitable polymer, composite, or metal. Furthermore, the system 10 of FIGS. 19-25 includes an additional panel 22A that is connected to the other panel 22 by horizontally extending, interlocking features 154 and 156, as best seen in FIGS. 20 and 21.

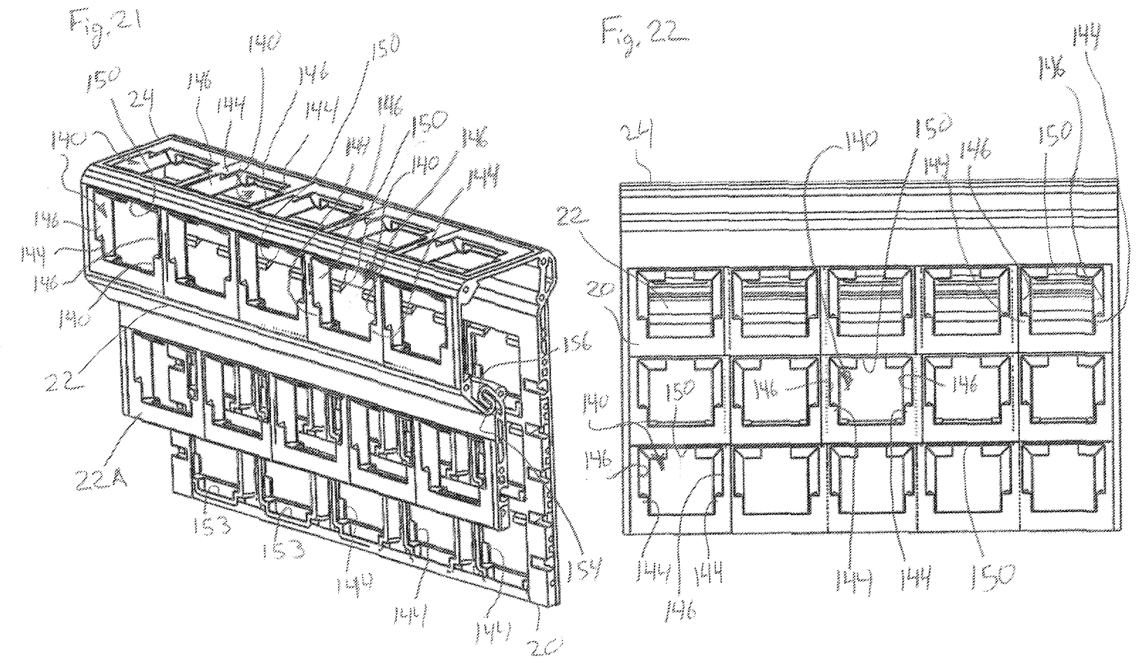

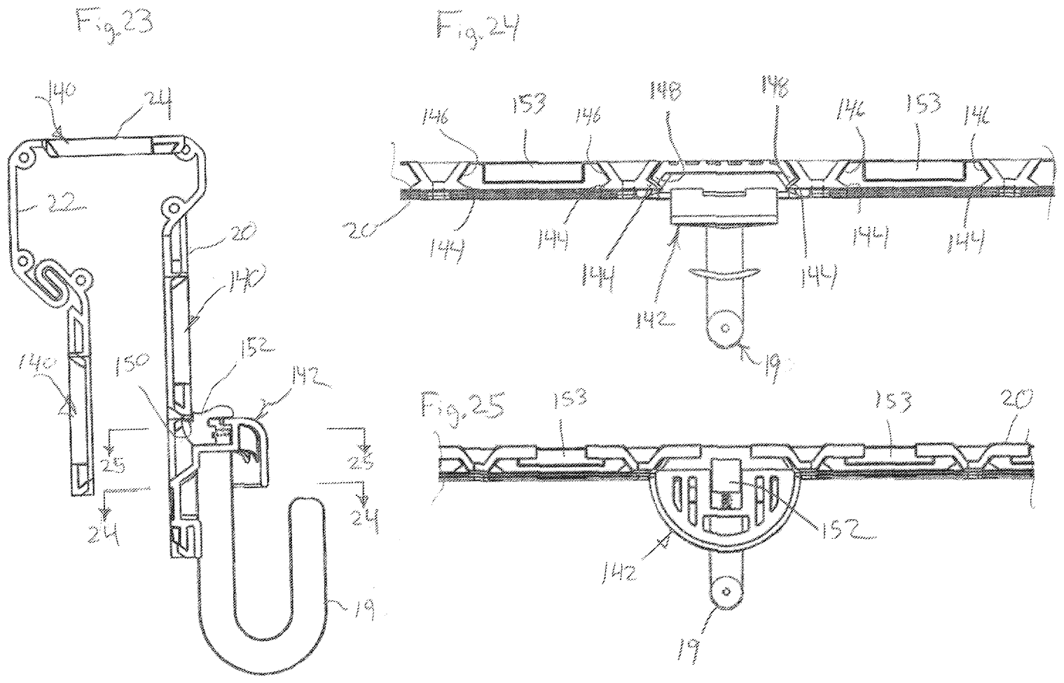

FIGS. 26-28 show another embodiment of the system 10 wherein there as first set 160 of first, second, and third frame members 20, 22, and 24 spaced horizontally from a second set 162 of first, second, and third frame members 20, 22, and 24. The mount structures 26 are provided in the form of horizontally extending mount rails 164 that extend from one set 160 to the other set 162 and are supported by the first and second frame members 20 and 22 of each set 160, 162. As best seen in FIG. 28, in the illustrated embodiment, each of the sets 160 and 162 are formed so that the first, second and third frame members 20, 22, and 24 are defined by a single, unitary component, with the frame members 20 and 22 having reliefs or openings 166 that support and receive the rails 164 and that are shaped to conform to at least a portion of the exterior profile of the rails 164. Securing members in the form of set screws 168 are provided to secure the rails 164 in the reliefs 166. While the embodiments of the rails 164 shown in FIGS. 26-28 differ somewhat from the rails 38, it should be understood that the preferred embodiments for the rails 164 have the same mount structure features 40, 42, 44, and 46 as the rails 38 for engaging a quick-connect accessory mount 18.

It should be noted that FIGS. 1, 2, 10, 11, 17, 19,26, and 28 show an aerial work platform 12 with an electrical insulating liner 180 that overlays the interior surface 28 of the sidewalls 14 and corners 70 and partially overlays the rim 17, and that the liner 180 isn't shown in some of the other views, including some of the sections views, for purposes of illustration to show alternate types of work platforms 12. As best seen in FIG. 28, when the platform 12 includes a liner 180, the frame members 20 overlay the liner 180 in addition to overlaying the interior surface 28 of the sidewalls 14 and that the frame member 24 also overlays the liner 180 in addition to overlaying the rim 17.

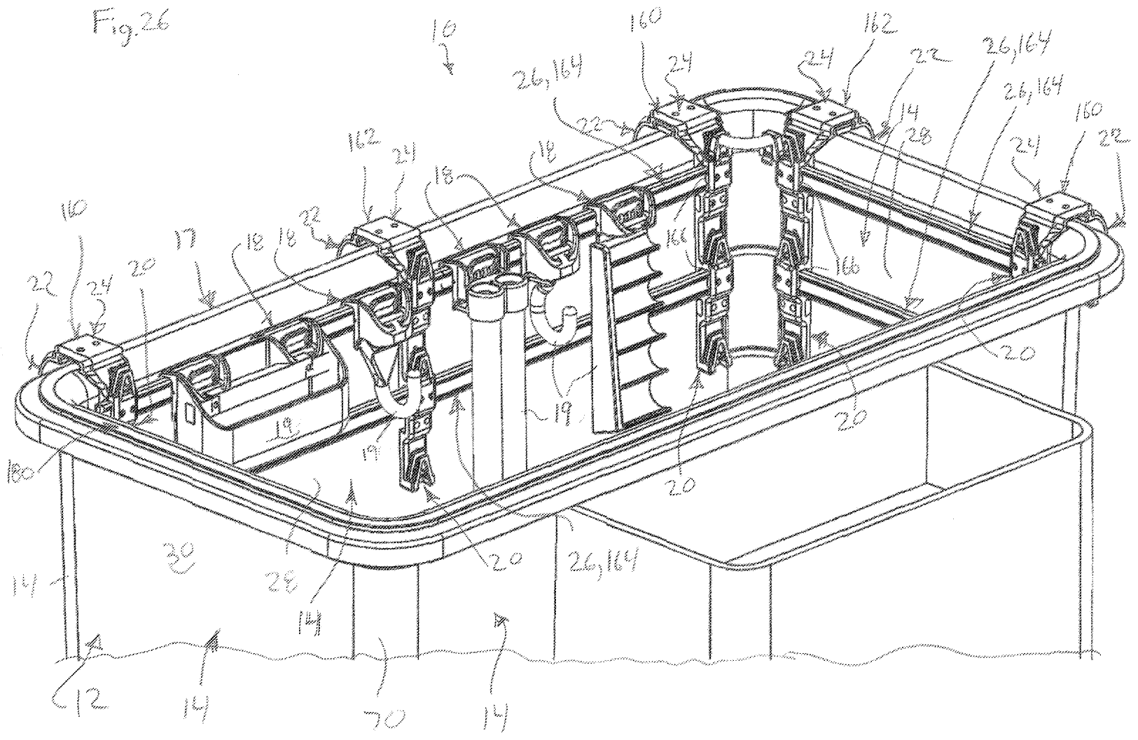

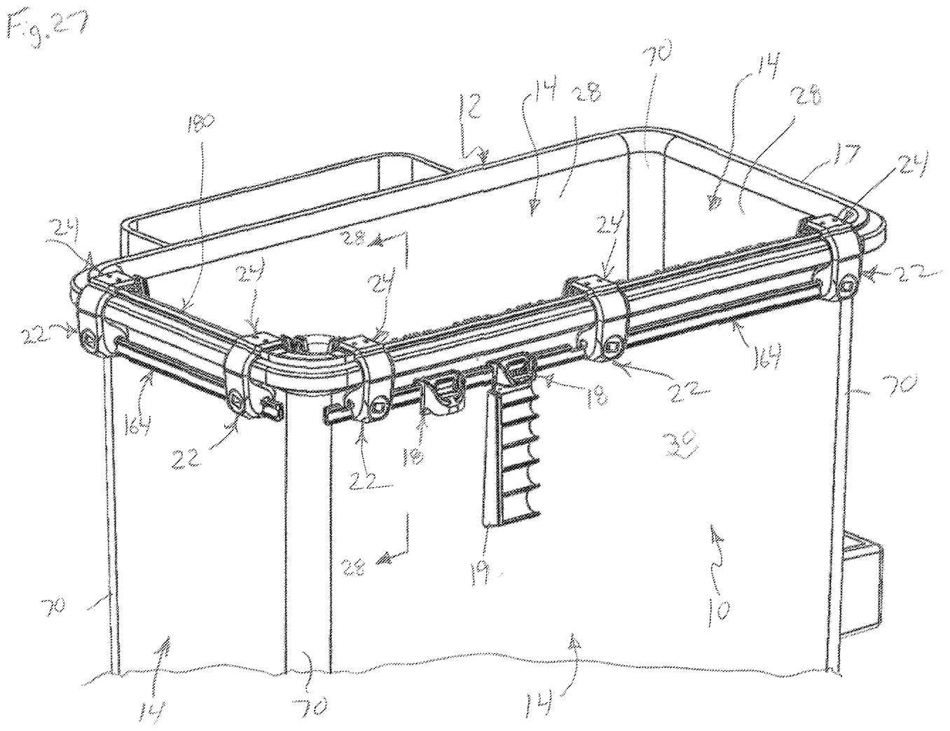

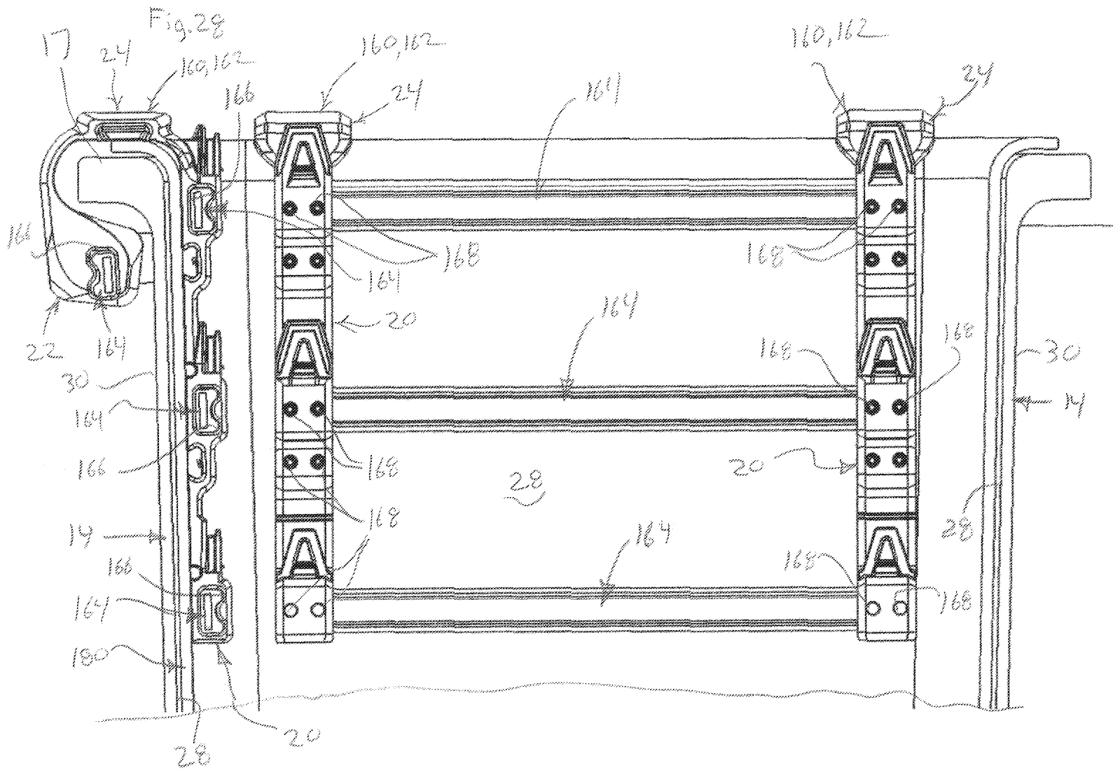

One highly preferred embodiment for the quick-connect accessory mount 18 is shown in FIGS. 1, 26, 27, and 29-36. It should be understood that this quick-connect accessory mount 18 is not limited to use with the other components of the system 10 and can be used in other accessory mount system having other accessory mount structures that are compatible with the quick-connect accessory mount 18, including for example accessory mount systems that utilize mount rails. The quick-connect accessory mount is shown in more detail in FIGS. 29-36 and includes frame 190, a catch 192, and a user actuated lever 194. As best seen in FIG. 30, in the illustrated embodiment, the frame 190 includes a first surface 196, a second surface 198 spaced from the first surface 196 and facing the first surface 196, a third surface 199 extending from the first surface 196 to the second surface 198, and a channel 200 defined between the first and second surfaces 196 and 198 to receive a mount structure, which in the illustrated embodiment is the rib 42 of one of the rails 38, 164. In this regard, the frame defines a gap, shown at 202 in FIG. 30, through which the rib 42 must pass to be inserted into the channel 200. It should be understood that the frame 190 is illustrated somewhat diagrammatically in FIGS. 29-34 and that the frame 190 will typically include additional structure that allows the mount 18 to support and carry an accessory or accessory carrier 19, such as shown in FIGS. 1, 26, and 27, and that the specific structure will vary depending upon the specific accessory or accessory carrier 19 that is to be supported and carried by the mount. For example, the frame 190 could include a hook 19 if the accessory to be carried is a rope, cable, or tool that has a loop lanyard. As another example, the frame 190 could include a structure that is shaped to be somewhat conforming to the housing of a battery powered hand tool, such as a battery powered drill or driver. As a further example, the frame 190 could include a metal, polymer, composite or leather tube or loop 19 if the accessory is a hand tool such as a hammer or screwdriver or a pole. As a further example, the frame 190 could include snap-fit reliefs 19 if the accessory is a plurality of nut-driver sockets. In another example, the frame 190 could include a pocket 19 that is configured to carry a tape measure or configured to carry accessories in the form of a plurality of nails, screws, bolts, or nuts.

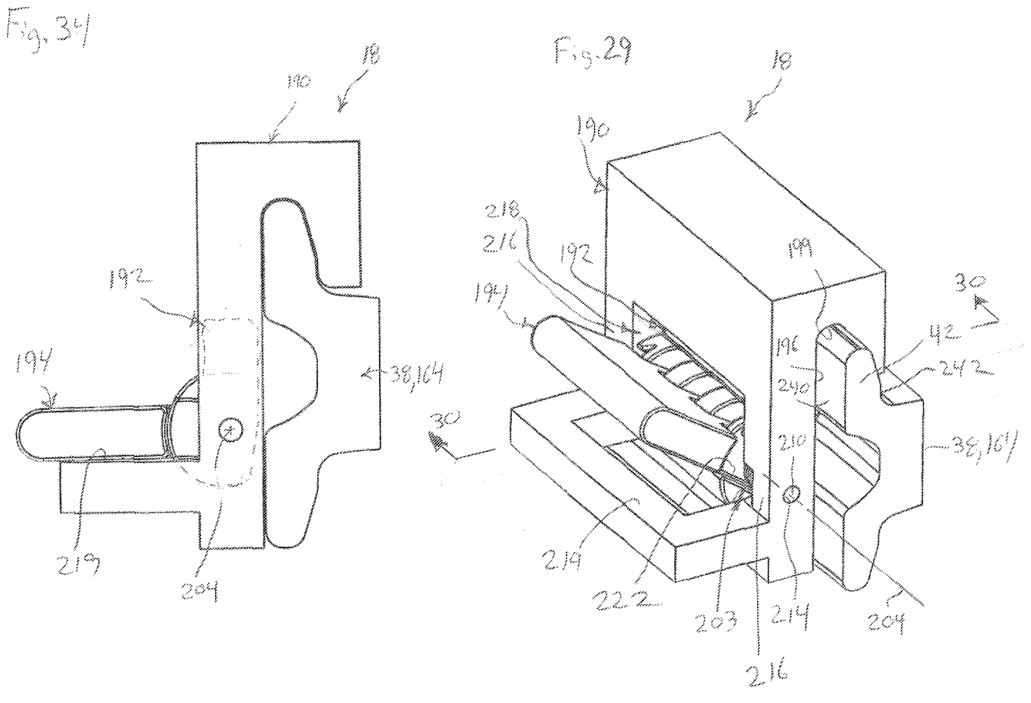

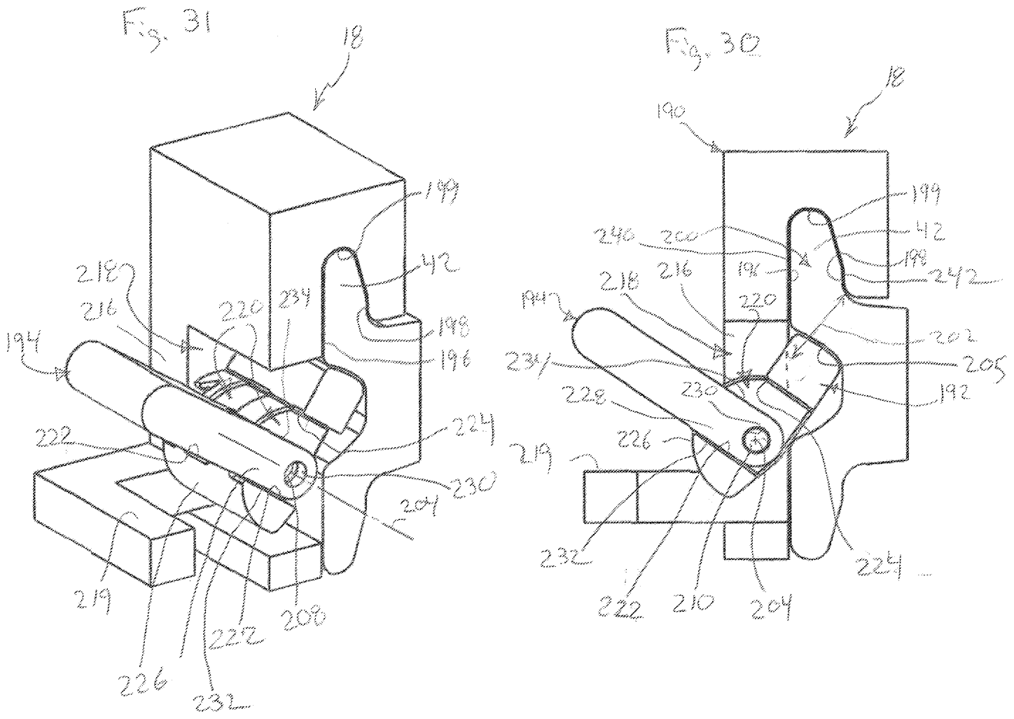

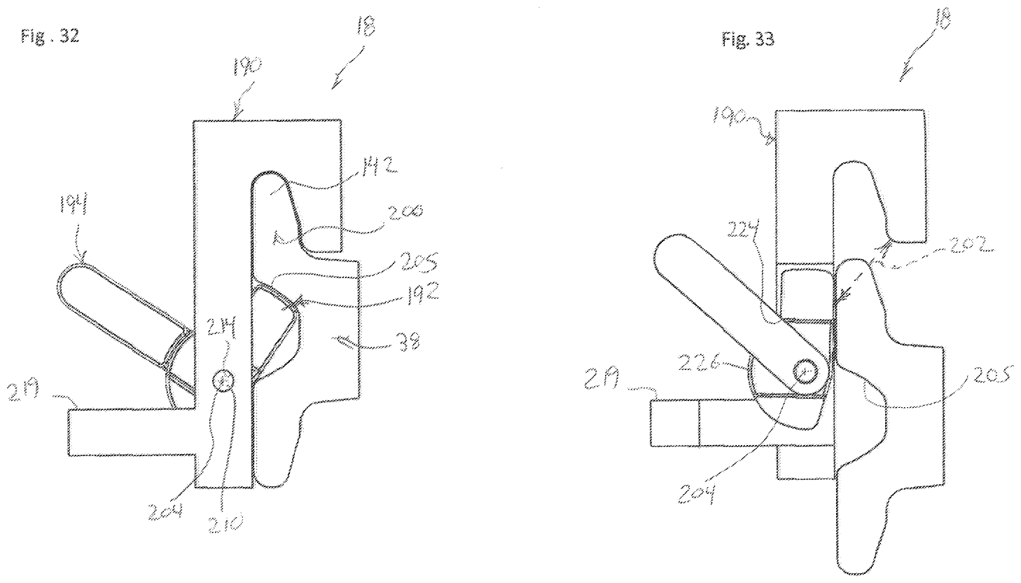

The catch 192 is mounted to the frame 190 to move between a release position shown in FIGS. 33 and 34 and a lock position shown in FIGS. 29-32. In the preferred embodiment, the catch 192 is biased toward the lock position by a spring 203 engaged between the catch 192 and the frame 190. In this regard, as previously discussed in connection with the catch 134, any suitable spring can be used but in the illustrated and preferred embodiment, the spring 203 is a helical torsion spring with one leg engaged against a stop on the frame 190 and another leg engaged against a stop on the catch 192. The user actuated lever 194 is mounted to move relative to the frame 190 between a ready position, shown in FIGS. 29-33, and an unlock position, shown in FIG. 34. The lever is connected to the catch 192 to allow a user to actuate the catch 192 from the lock position to the release position in response to the user actuating the latch 194 from the ready position to the unlock position. In the preferred and illustrated embodiment, the release lever 194 and the catch 192 are connected to allow relative motion between the lever 194 and the catch 192 as the catch 192 is actuated from the lock position to the release position by a mount structure, such as the rib 42, being inserted into the channel 200. This feature helps to prevent pinching of a user's fingers by between the frame 190 and the lever 194 when the catch 192 is actuated from the lock position to the release position by the quick-connect accessory mount 18 being attached to a mount structure, such as a rib 42 on one of the rails 38, 164.

In the preferred embodiment, the catch 192 and the lever 194 are both mounted to pivot relative to the frame 190 about a horizontal axis 204, but it should be understood that in some applications it may desirable for one or both of the catch 192 and/or the lever 194 to have a different type of motion relative to the frame 190, including for example linear or curvilinear translations or a combination of translations and rotations/pivoting. It may also be desirable in some applications for the lever 194 to pivot about a different axis than axis 204. In the lock position, the catch 192 extends from the frame 190 to a position that blocks removal of the rib 42 from the channel 200. In the illustrated and preferred embodiment, the catch 192 extends from the first surface 196 into the gap 202 in the lock position and will engage against a downwardly facing surface 205 in the concave portion 46 of the rail 38, 164 to prevent removal of the rib 42 from the channel 200. In the release position, the catch 192 is positioned relative to the channel 200 to allow the rib 42 to be inserted into and removed from the channel 200. In the illustrated and preferred embodiment, the catch 192 is removed from the gap 202 in the release position.

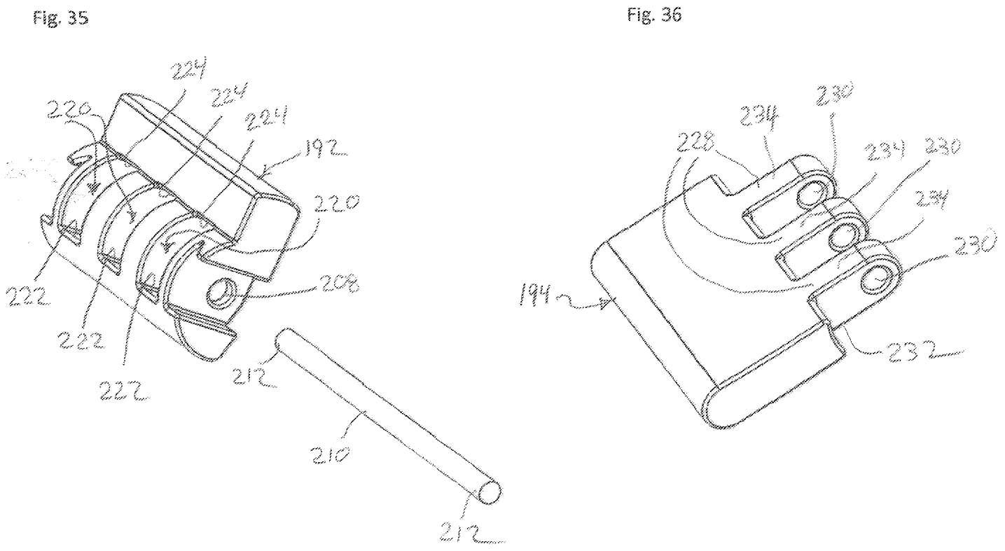

Turning now to a more detailed description of one highly preferred embodiment of the frame 190, catch 192 and lever 194, as best seen in FIG. 35, in the illustrated embodiment, the catch 192 includes a journal bore 208 that is sized to receive a pivot pin 210 to allow the catch 192 to pivot about the pin 210 between the release and lock positions. The pin 210 has opposite ends 212 that are each press fit into one of a pair of mount bores 214 (best seen in FIG. 29) formed in the spaced sidewalls 216 of the frame. The spaced side walls 216 define an opening 218 in the frame 190 that receive portions of the catch 192 and the lever 194. The frame 190 further includes a stop surface 219 that engages the lever 194 in the unlock position to limit the pivoting of the lever 194 relative to the frame 190 as the lever 194 moves from the ready position to the unlock position.

The catch 192 further includes a plurality of spaced, circumferentially extending slots 220, with each slot 220 extending from a first stop surface 222 to a second stop surface 224. Each slot 220 extends transversely to the bore 208 from a semicylindrical outer surface 226 to depth that is past the bore 208. As best seen in FIG. 36, the lever 194 includes a plurality of spaced fingers 228, with each finger 228 having a journal bore 230 that is sized to receive the pivot pin 210 to allow the lever to pivot about the pin 210 between the ready and unlock positions. The fingers 228 are spaced and sized so that each finger 228 is slidably received in a corresponding one of the slots 220 and extends into the corresponding slot 220 to a depth that allows the bore 230 to receive the pivot pin 210 when the catch 192 and latch 194 are in assembled together. The stop surface 222 in each slot 220 engages against a stop surface 232 on the corresponding finger 228 when the catch 192 in in the lock position and the lever is in the ready position. The engagement allows the lever 194 to actuate the catch 192 from the lock position to the release position in response to a user actuating the lever 194 from the ready position to the unlock position. The circumferential spacing between each of the stop surfaces 222 and 224 is sufficient to allow the catch 192 to pivot from the lock position to the release position without engaging against an opposite surface 234 on each the fingers 228, thereby allowing a mount structure, such as a rib 42, to actuate the catch 192 from the lock position to the release position while the lever remains stationary relative to the frame 190 and the catch 192 as the mount structure is inserted into the channel 200.

In the illustrated embodiment, the first and second surfaces 196 and 198 are planar surfaces that extend essentially parallel to each other. Similarly, the rib 42 includes a pair of spaced planar surface 240 and 242 that extend parallel to each other and are aligned with the surfaces 196 and 198, respectively, when the rib 42 is fully inserted into the channel 200. In this regard, it should be noted that the parallelism of the surfaces 196 and 198 to each other and of the surfaces 240 and 242 are limited by typical manufacturing tolerances and process. For example, in preferred embodiments, the frame 190 will be a molded from a suitable material, such as a suitable polymer, composite, or metal, and the parallelism will be limited by any draw angles that are required to mold the surfaces 196 and 198 and the manufacturing tolerances for such molding processes. As another example, in some preferred embodiments, the rails 38, 164 will be molded from a suitable material, such as a suitable polymer, composite, or metal, and the parallelism of the surfaces 240 and 242 will be limited by the manufacturing tolerances for such molding processes.

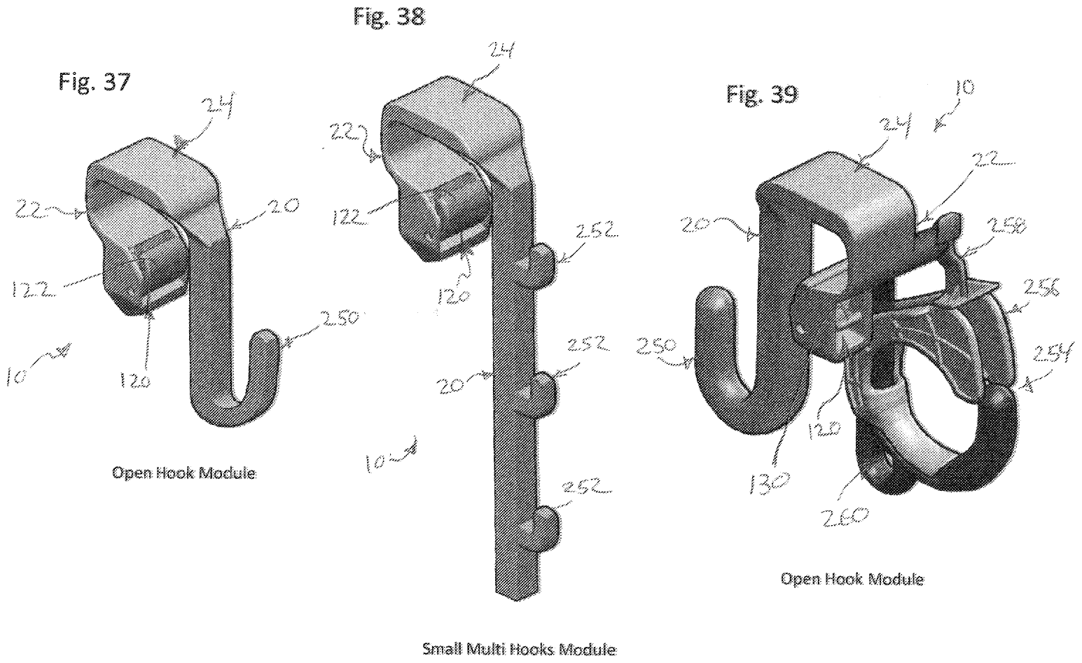

Additional embodiments of the mount system 10 are shown in FIGS. 37-47 wherein the accessories or accessory mount/holders 19 are integrated with or into the one or both of the first and second frame members 20 and 22, which eliminates the need for any mount structures 26 and quick-connect accessory mounts 18. Furthermore, each of the embodiments incorporates one or more of the quick-connect mechanisms 120 for releasably mounting the frames 20, 22, and 24 to the sidewall 14 and lip 17, as previously described in connection with FIGS. 17 and 18, with the quick-connect mechanism 20 being mounted in the frame member 22 of each embodiment. A more detailed description of each embodiment is provided below.

FIG. 37 shows an embodiment of the system 10 wherein the frame member 20 includes an accessory mount 19 in the form of an open hook 250, with the frame members 20, 22, and 24 and the hook 250 being formed as a unitary, one-piece component.

FIG. 38 shows an embodiment of the system 10 wherein the frame member 20 includes accessory mounts 19 in the form of a plurality of open hooks 252, which in the illustrated embodiment are of a smaller size than the hook 250 shown in FIG. 37. Again, the frame members 20, 22, and 24 and the hooks 252 are formed as a unitary, one-piece component.

FIG. 39 shows an embodiment of the system 10 which includes the open hook 250 of FIG. 37 plus an additional safety hook 254 that is integrated into the frame member 22. The safety hook 254 includes a gate 256 that is retained in a closed position by a user actuated lock member 258. A tether opening 260 is also included on the hook 254 to allow a tether or lanyard to be connected to the hook 254. In the illustrated embodiment, the frame members 20, 22, and 24 are formed as a unitary, one-piece component.

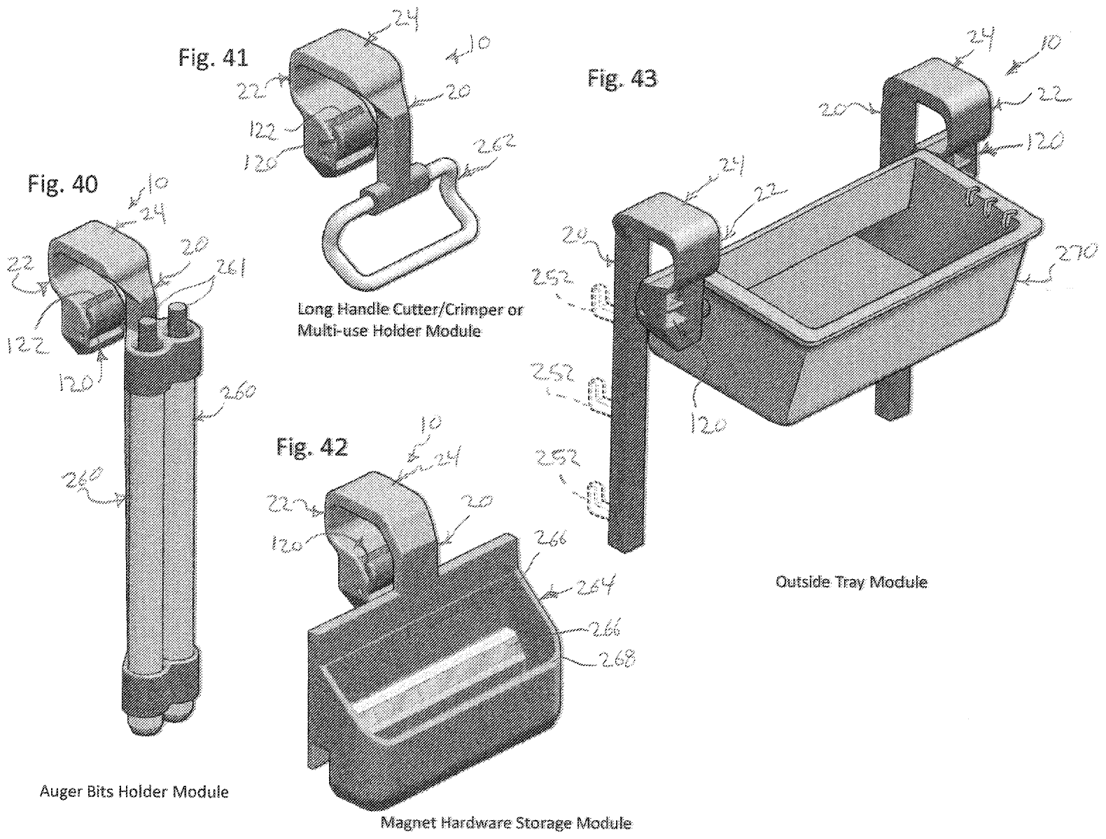

FIG. 40 shows an embodiment of the system 10 wherein the frame member 20 includes accessory mounts 19 in the form of a pair of cylindrical shaped tubes or pockets 260 that are suitable for receiving drill or auger bits 261 or other elongate tools. In the illustrated embodiment, the frame members 20, 22, and 24 are formed as a unitary, one-piece component.

FIG. 41 shows an embodiment of the system 10 wherein the frame member 20 includes an accessory mount 19 in the form of a multi-use tool loop 262 that can receives the handle(s) of a tool, such as a long handled cutter or crimper. In the illustrated embodiment, the loop has a rectangular shape and is formed from a suitable metal, and the frame members 20, 22, and 24 are formed as a unitary, one-piece component.

FIG. 42 shows an embodiment of the system 10 wherein the frame member 20 includes an accessory 19 in the form of a open top storage module of pocket 264 that can receive tools or hardware such as, for example, nuts, bolts, nails, staples, cable ties, etc. In the illustrated embodiment, the module 264 includes horizontally extending magnetic strips 266 fixed in a generally rectangular shaped pocket body 268, with the frame members 20, 22, and 24 and the pocket body 268 being formed as a unitary, one-piece component.

FIG. 43 shows an embodiment of the system 10 that includes an accessory 19 in the form of a storage module or pocket 270 that is carried by and between a pair of horizontally spaced frame members 22. In the illustrated embodiment, each of the frame members 22 is formed a unitary, one-piece component with corresponding frame members 20 and 24. As shown in phantom, at least one of the frame members 20 can optionally include a plurality of the hooks 252.

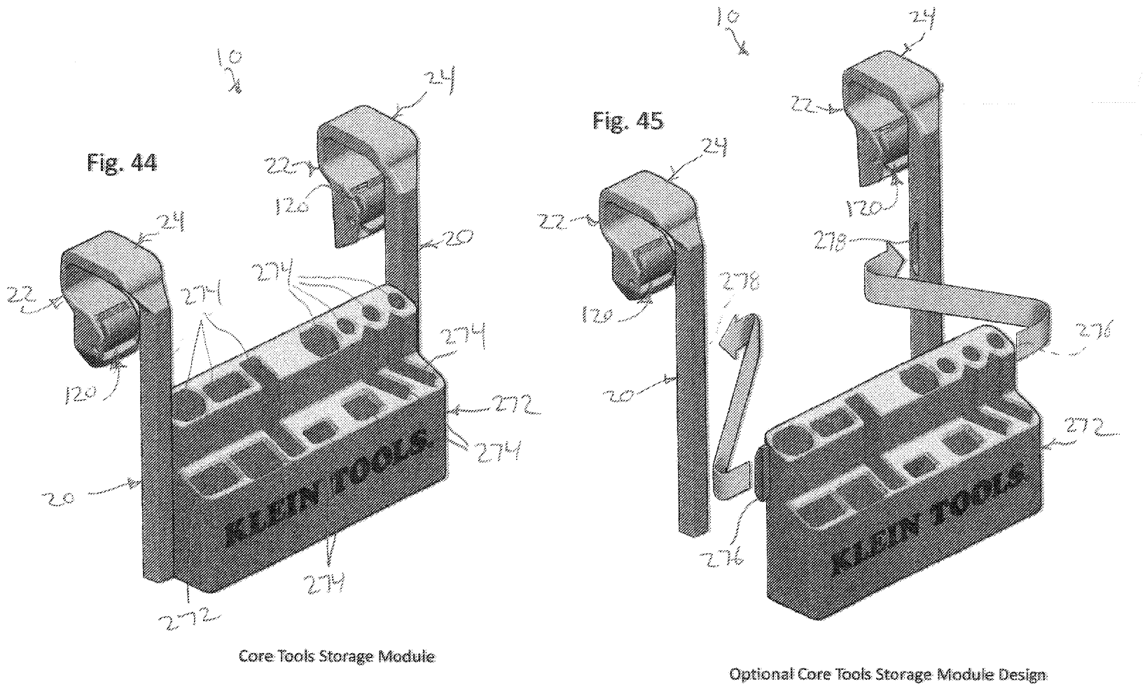

FIGS. 44 and 45 show an embodiment of the system 10 that includes an accessory 19 in the form of a storage module 272 that is carried by and between a pair of horizontally space frame members 20, with the module 272 including a plurality of vertically extending pockets or receptacles 274, each of which is and shaped and sized to better accommodate certain types or classes of tools or hardware components. In the illustrated embodiment, each of the frame members 22 is formed as a unitary, one-piece component with corresponding frame members 20 and 24, and the module 272 has a pair of male features 276 that are snap fit into corresponding female feature 278 formed in each of the frame members 20. In alternate embodiment, the module 272 and all of the frame members 20, 22, and 24 are formed as a unitary, one-piece component.

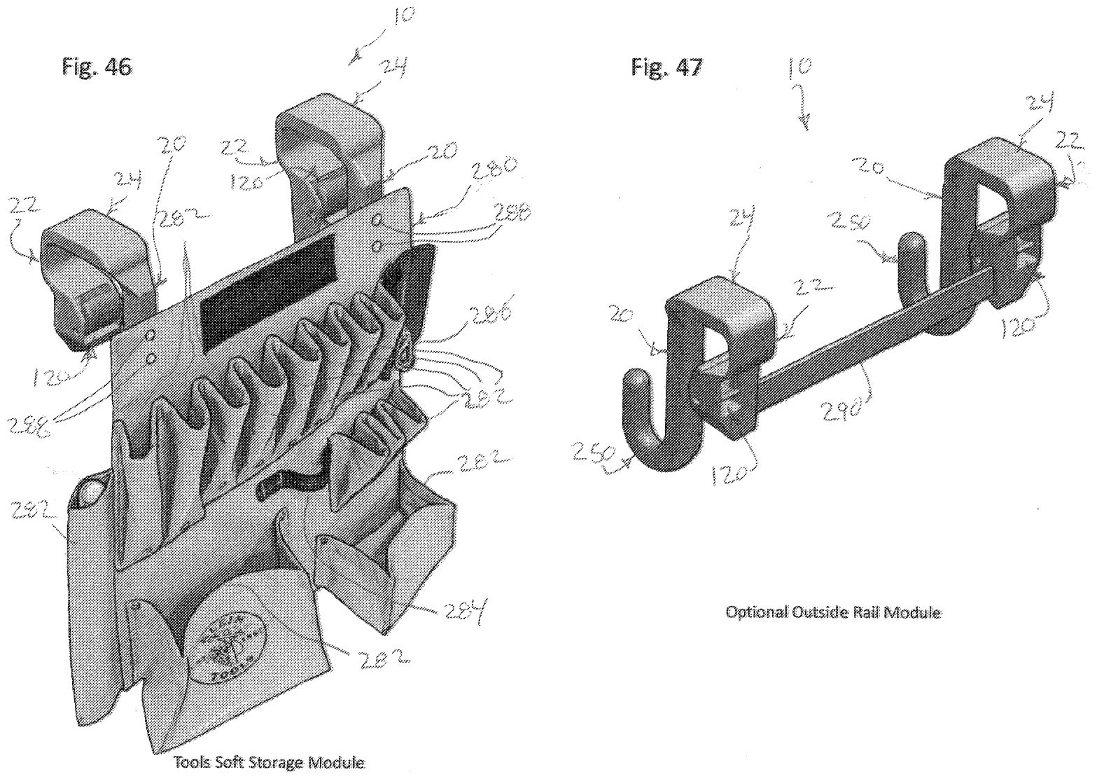

FIG. 46 shows an embodiment of the system 10 that includes an accessory 19 in the form of a soft storage module 280 that is carried by and between a pair of horizontally space frame members 20, with the module 280 being formed of a suitable fabric, textile, canvas, leather, vinyl, or other such material and including a plurality of vertically extending pockets or receptacles 282, each of which is shaped and sized to better accommodate certain types or classes of tools or hardware components. In the illustrated embodiment, the module 280 also includes a fabric or textile loop 284 and a snap hook 286 In the illustrated embodiment, each of the frame members 22 is formed as a unitary, one-piece component with corresponding frame members 20 and 24, and the module 280 is connected to each of the frame members 20 by suitable fasteners 288, such as suitable rivets 288.

FIG. 47 shows an embodiment of the system 10 that includes a pair of horizontally spaced frame members 20, each of which includes an accessory mount 19 in the form an open hook 250 as previously described in connection with FIG. 37, with each of the frame members 20 being formed a unitary, one-piece component with corresponding frame members 22 and 24. Additionally, the illustrated system 10 includes a horizontally extending mount rail 290 extending between and carried by the spaced frame members 22.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the accessory mount system 10 and the quick-connect accessory mount 18 are shown in the figures, it should be understood that this disclosure anticipates variations in the specific details of each of the disclosed components and features of the accessory mount system 10 and the quick-connect accessory mount 18 and that no limitation to a specific form, configuration, or detail is intended unless expressly and specifically recited in an appended claim.

For example, while specific and preferred forms have been shown for the wall panels 20 and 22 of FIGS. 1-12 which include the through openings 32 and 34, in some embodiments, such as those shown in FIGS. 16A-18, it may be desirable for the wall panels 20 and 22 to not include such openings. As another example, it may be desirable for one of the panels 20 or 22 to include such openings, and the other panel 20 or 22 to not include such openings. As a further example, it may be desirable for one of the panels 20 or 22 to have the rails 38 formed as an integral, unitary part of the wall panel 20 or 22, such as is shown in FIGS. 3 and 4, and for the other panel 20 or 22 to have each of the rails 38 formed as a separate component that is assembled to the panel 20 or 22. Alternatively, it may be desirable for one or more of the rails 38 to be formed as an integral, unitary part of the wall panel 20 and for one or more other of the rails 38 to be formed as separate component(s) that is assembled to the panel 20. In another example, while it is preferred for each of the rails 38 to include downwardly extending rib 50, in some applications it may be desirable for one or more of the ribs to no include a downwardly extending rib 50. Similarly, as another example, while it is preferred that each of the ribs 50 include the outwardly facing concave portion 46, in some applications it may be desirable for one or more of the rails 38 to not include the outwardly facing concave portion 46. In a further example, while illustrated embodiments show the rails 38 being provided on the wall panels 20 and 22, in some embodiments it may be desirable to provide one or more rails 38 on the frame member 24. As yet another example, while the illustrated embodiments of the corner member 72 show one mount rod 99, in some embodiments it may be desirable of the corner member 72 to include more than one mount rod 99, or no mount rod 99. Similarly, in some applications it may be desirable for the corner member to include more or fewer of the mounts 90 than shown in the illustrated embodiments. Furthermore, in some applications it may be desirable for the corner member 72 to include other types of accessory mounts than shown in the illustrated embodiments. As another example, in some applications it may be desirable for the recessed slots 140 of the embodiments shown in FIGS. 19-25 to be provided in a different form that includes a different number, orientation and/or configuration of ribs 144, many of which are known for use with quick-connect mechanisms. For example, while each recessed slot includes two of the ribs 144, in some applications it may be desirable for each slot 140 or some of the slots 140 to include a single rib, while in some applications it may be desirable for each slot 140 or some of the slots 140 to include three ribs. In a further example, in some applications it may be desirable for one or more of the frame members 20, 22, and 24 to include one or more rails 38 in combination with one or more of the recessed slots 140. In another example, while a highly preferred embodiment of a quick-connect accessory mount 18 has been shown in Figs., to include fingers 228 on the lever 194 that are received in slots 220 in the catch 192, in some applications it may be desirable to include other structure that to allow relative motion between the lever 194 and the catch 192 as the catch 192 is actuated from the lock position to the release position by a mount structure while also allowing the lever 194 to actuate the catch 192 from the lock position to the release position in response to a user actuating the lever 194 from the ready position to the unlock position.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. An accessory mount system for use with an elevated lift platform having sidewalls extending upwardly from a base to a rim, the mount system comprising:
a first frame member supporting a first horizontally extending mount rail;
a second frame member supporting a second horizontally extending mount rail; and
a third frame member configured to connect the first frame member and the second frame member while extending over a rim of a lift platform with the first frame member and first horizontally extending mount rail overlaying an interior side of a sidewall of the lift platform and the second frame member and the second horizontally extending mount rail overlaying an exterior side of the sidewall of the lift platform.

2. The mount system of claim 1 wherein the first frame member supports a plurality of horizontally extending mount rails.

3. The mount system of claim 2 wherein the first, second, and third frame members and the rails are formed as a unitary component.

4. The mount system of claim 1 wherein each of the mount rails has an upper horizontally extending edge.

5. The mount system of claim 4 wherein each of the mount rails has an outwardly facing concave portion located below the upper horizontally extending edge, the concave portion extending horizontally over a length of the rail.

6. The mount system of claim 4 wherein each of the mount rails has a lower horizontally extending edge spaced vertically below the upper horizontally extending edge.

7. The mount system of claim 6 wherein each of the mount rails has an outwardly facing concave portion located between the upper and lower horizontally extending edges, the concave portion extending horizontally over a length of the rail.

8. The mount system of claim 1 wherein the first frame member comprises a vertical wall panel.

9. The mount system of claim 8 wherein the vertical wall panel has an array of openings extending through the wall panel.

10. The mount system of claim 1 further comprising at least one quick-connect accessory mount configured to engage each of the mount rails.

11. An accessory mount system for use with an elevated lift platform having sidewalls connected to each other by corner walls, the sidewalls and corner walls extending upwardly from a base to a rim, the mount system comprising:
a corner frame member configured to extend over and engage a corner wall of a lift platform, the corner frame member comprising a first portion that overlays a rim of the lift platform and a second portion that overlays an interior side of the corner wall, the corner frame member supporting at least one accessory mount.

12. The accessory mount system of claim 11 further comprising at least one accessory mount structure carried on the corner frame member.

13. The accessory mount system of claim 12 wherein the at least one accessory mount structure comprises a hook shaped accessory mount mounted to the corner frame member to pivot relative to the corner frame member between a stowed position and a ready position wherein one or more accessories can be hung from the hook shaped accessory mount.

14. The accessory mount system of claim 12 wherein the at least one accessory mount structure comprises an arcuate shaped rod mounted to the corner frame member to pivot between a stowed position wherein the rod overlays a concave surface of the corner frame member and a deployed position wherein the rod curves oppositely outwardly from the concave surface to allow one or more accessories to be hung from the rod.

15. A quick-connect mechanism for releasably mounting an accessory to an accessory mount system, the quick-connect mechanism comprising:
a frame comprising a first surface, a second surface spaced from the first surface and facing the first surface, and a channel defined between the first and second surfaces to receive a mount structure to which the mechanism can be mounted;
a catch mounted to the frame to pivot between a release position and a lock position, in the lock position the catch extends from the frame to a position that blocks removal of a mount structure received in the channel, in the release position the catch is positioned relative to the channel to allow a mount structure to inserted into and removed from the channel, the catch being biased toward the lock position; and
a user actuated release lever connected to the catch to allow a user to actuate the catch from the lock position to the release position, the release lever and the catch connected to allow relative movement between the release lever and the catch as the catch is actuated from the lock position to the release position by a mount structure being inserted into the channel.

16. The quick-connect mechanism of claim 15 wherein the release lever is mounted to pivot relative to the frame between a ready position and a unlock position, the catch moving from the lock position to the release position in response to the release lever moving from the ready position to the unlock position.

17. The quick-connect mechanism of claim 16 wherein the release lever and the catch are mounted to pivot about a common axis.

18. A quick-connect mechanism for releasably mounting an accessory to an accessory mount system, the quick-connect mechanism comprising:
a frame comprising a first surface, a second surface spaced from the first surface and facing the first surface, and a channel defined between the first and second surfaces to receive a mount structure to which the mechanism can be mounted, at least a portion of the first surface and at least a portion of the second surfaces are planar;
a catch mounted to the frame to pivot between a release position and a lock position, in the lock position the catch extends from the frame to a position that blocks removal of a mount structure received in the channel, in the release position the catch is positioned relative to the channel to allow a mount structure to inserted into and removed from the channel; and
a user actuated release lever connected to the catch to allow a user to actuate the catch from the lock position to the release position.

19. The quick-connect mechanism of claim 18 wherein the frame defines a gap through which a mount structure must pass to be inserted into the channel, and the catch extends into the gap in the lock position.

20. The quick-connect mechanism of claim 19 wherein the catch is removed from the gap in the release position.
